(19) United States
(12) Patent Application Publication
(10) Pub. No.: US 2008/0274425 A1
(43) Pub. Date: Nov. 6, 2008

(54) POSITIVE WORKING LIGHT SENSITIVE PLANOGRAPHIC PRINTING PLATE MATERIAL

(75) Inventor: Hidetoshi Ezure, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/853,269

(22) Filed: Sep. 11, 2007

(30) Foreign Application Priority Data
Sep. 19, 2006 (JP) 2006252452

(51) Int. Cl. G03C 1/73

(52) U.S. Cl. 430/286.1

(57) ABSTRACT

Disclosed is a positive working light sensitive planographic printing plate material comprising an aluminum support and provided thereon, a lower layer and an upper layer in that order, at least one of the upper and lower layers containing a fluoroalkyl group-containing acryl resin, wherein the upper layer contains an alkali soluble resin and a light-to-heat conversion material, and the lower layer contains an alkali soluble resin and an acid decomposable compound represented by the following formula (1),

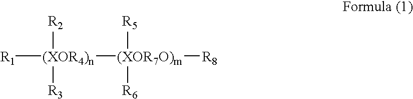

This application is based on Japanese Patent Application No. 2006-252452, filed on Sep. 19, 2006 in Japanese Patent Office, the entire content of which is hereby incorporated by reference.

### FIELD OF THE INVENTION

The present invention relates to a planographic printing plate material comprising positive working image formation layer used in a computer to plate (hereinafter referred to as CTP) system, and particularly to a planographic printing plate material capable of forming an image on near infrared laser exposure, which excels in image uniformity, sensitivity, development latitude and chemical resistance.

### BACKGROUND OF THE INVENTION

In recent years, printing image data are digitized and a so-called CTP system is widely used which comprises exposing a planographic printing plate material employing laser signals to which the digitized data are converted. Presently, laser technique is markedly developed, and a compact solid or semiconductor laser with high output power, which has an emission wavelength of from near-infrared to infrared regions, is available from the market. Such a laser is extremely useful as a light source for manufacturing a printing plate employing digitized data from a computer.

In recent years, an exposure device having multi-channels or multi-heads has been developed in order to realize high productivity, i.e., shortage of exposure time. Increase of a screen number or high precision of an FM screen proceeds from demand for prints with high quality image. In prints in which high quality image is required, image unevenness sometimes occurs at from medium to big dot image regions, which has been non-problematic hitherto In order to overcome such image unevenness, an exposure device has been improved but a satisfactory device is not obtained. Thus, improvement of a planographic printing plate material is also desired.

As a method for obtaining high sensitivity, there is proposed a method in which a light sensitive layer is separated into two layers. A planographic printing plate material is disclosed in for example Japanese Patent No. 3583610, which comprises a recording layer comprised of an alkali soluble lower layer containing polyvinyl phenol and an upper layer containing a water-insoluble but alkali soluble resin and an infrared absorbing dye, the upper layer greatly increasing its alkali solubility on light exposure.

However, this planographic printing plate material increases sensitivity, but is insufficient in view of developing latitude and image uniformity, which results from nature of resin in the upper layer.

Further, there is proposed an image formation material which comprises a support and provided thereon, a lower layer containing a specific monomer and an upper light sensitive layer in that order (see Japanese Patent No. 11-218914).

However, this image formation material improves increases sensitivity and development latitude, but is insufficient in view of chemical resistance and image uniformity.

Thus, it has been difficult to obtain a planographic printing plate material which provides not only excellent image uniformity for realizing high precision image but also excellent sensitivity, development latitude and chemical resistance.

### SUMMARY OF THE INVENTION

The present invention has been made in view of the above. An object of the invention is to provide a positive working light sensitive planographic printing plate material which provides not only excellent image uniformity for realizing high precision image but also excellent sensitivity, development latitude and chemical resistance.

### DETAILED DESCRIPTION OF THE INVENTION

The above object of the invention can be attained by the followings:

1. A positive working light sensitive planographic printing plate material comprising an aluminum support and provided thereon, a lower image formation layer (hereinafter also referred to simply as lower layer) and an upper image formation layer (hereinafter also referred to simply as upper layer) in that order, wherein the upper layer contains an alkali soluble resin and a light-to-heat conversion material, and at least one of the upper and lower layers contains a fluoroalkyl group-containing acryl resin, and wherein the lower layer contains an alkali soluble resin and an acid decomposable compound represented by the following formula (1),

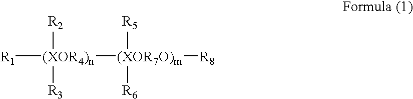

wherein n represents an integer of 1 or more; m represents an integer of 0 or more; X represents a carbon atom or a silicon atom; R₄ represents an ethyleneoxy group or a propyleneoxy group; R₂ and R₅ independently represent a hydrogen atom, an alkyl group or an aryl group; R₃ and R₆ independently represent an alkyl group or an aryl group, provided that R₂ and R₃ may combine with each other to form a ring or R₅ and R₆ may combine with each other to form a ring; R₇ represents an alkylene group; R₁ represents a hydrogen atom, an alkyl group, an aryl group, an alkoxy group, an alkyleneoxy group or a halogen atom; and R₅ represents a hydrogen atom, —XR₂R₃R₁ or —XR₅R₆R₁.

2. The positive working light sensitive planographic printing plate material of item 1 above, wherein the upper layer further contains a fluoroalkyl group-containing acryl resin.

3. The positive working light sensitive planographic printing plate material of item 1 or 2 above, wherein the acid decomposable compound represented by formula (1) is an acetal.

4. The positive working light sensitive planographic printing plate material of any one of items 1 through 3 above, wherein the lower layer further contains an acid generating agent.

5. The positive working light sensitive planographic printing plate material of item 4 above, wherein the acid generating agent is a compound represented by the following formula (2),

R¹—C(X)₂—C═O)—R² Formula (2)

wherein R¹ represents a hydrogen atom, a bromine atom, a chlorine atom, an alkyl group, an aryl group, an acyl group, an alkylsulfonyl group, an arylsulfonyl group, an iminosulfonyl group or a cyano group; R² represents a hydrogen atom or a monovalent organic substituent, provided that R¹ and R² may combine with each other to form a ring; and X represents a bromine atom or a chlorine atom.

6. The positive working light sensitive planographic printing plate material of any one of items 1 through 5 above, wherein the surface of the aluminum support is subjected to hydrophilization treatment with an aqueous polyvinyl phosphonic acid solution.

The present invention will be explained in detail below.

The positive working light sensitive planographic printing plate material of the invention comprises an aluminum support and provided thereon, a lower image formation layer and an upper image formation layer in that order, at least one of the upper and lower layers containing a fluoroalkyl group-containing acryl resin, wherein the upper layer contains an alkali soluble resin and a light-to-heat conversion material, and the lower layer contains an alkali soluble resin and an acid decomposable compound represented by the formula (1) above.

### (Aluminum Support)

As the aluminum support in the invention, an aluminum plate or an aluminum ally plate is used. As the aluminum alloy, there can be used various ones including an alloy of aluminum and a metal such as silicon, copper, manganese, magnesium, chromium, zinc, lead, bismuth, nickel, titanium, sodium or iron. An aluminum plate can be used which is manufactured according to various calender procedures. A regenerated aluminum plate can also used which is obtained by calendering ingot of aluminum material such as aluminum scrap or recycled aluminum.

It is preferable that the aluminum support in the invention is subjected to degreasing treatment for removing rolling oil prior to surface roughening (graining). The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting support is preferably subjected to desmut treatment in an aqueous solution of an acid such as phosphoric acid, nitric acid, sulfuric acid, chromic acid, or a mixture thereof, since smut is produced on the surface of the support.

The resulting aluminum plate is subjected to surface roughening treatment. The surface roughening methods include a mechanical surface roughening method and an electrolytic surface roughening method electrolytically etching the support surface. In the invention, surface roughening is preferably carried out in an acidic electrolyte solution containing hydrochloric acid, employing alternating current. Prior to this treatment, electrolytic surface roughening in an electrolyte solution containing nitric acid or mechanical surface roughening may be carried out.

Though there is no restriction for the mechanical surface roughening method, a brushing roughening method and a honing roughening method are preferable. The brushing roughening method is carried out by rubbing the surface of the support with a rotating brush with a brush hair with a diameter of 0.2 to 0.8 mm, while supplying slurry in which volcanic ash particles with a particle size of 10 to 100 μm are dispersed in water to the surface of the support. The honing roughening method is carried out by ejecting obliquely slurry with pressure applied from nozzles to the surface of the support, the slurry containing volcanic ash particles with a particle size of 10 to 100 μm dispersed in water. A surface roughening can be also carried out by laminating a support surface with a sheet on the surface of which abrading particles with a particle size of from 10 to 100 μm was coated at intervals of 100 to 200 μm and at a density of 2.5×10³ to 10×10³/cm², and applying pressure to the sheet to transfer the roughened pattern of the sheet and roughen the surface of the support.

After the support has been roughened mechanically, it is preferably dipped in an acid or an aqueous alkali solution in order to remove abrasives and aluminum dust, etc. which have been embedded in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous alkali solution of for example, sodium hydroxide is preferably used. The dissolution amount of aluminum in the support surface is preferably 0.5 to 5 g/m². After the support has been dipped in the aqueous alkali solution, it is preferable for the support to be dipped in an acid such as phosphoric acid, nitric acid, sulfuric acid and chromic acid, or in a mixed acid thereof, for neutralization.

When electrolytically surface roughening is carried out in an electrolytic solution containing mainly nitric acid, voltage applied is generally from 1 to 50 V, and preferably from 5 to 30 V. The current density used can be selected from the range from 10 to 200 A/dm², and is preferably from 20 to 100 A/dm². The quantity of electricity can be selected from the range of from 100 to 5000 C/dm², and is preferably 100 to 2000 C/dm². The temperature during the electrolytically surface roughening may be in the range of from 10 to 50° C., and is preferably from 15 to 45° C. The nitric acid concentration in the electrolytic solution is preferably from 0.1% by weight to 5% by weight. It is possible to optionally add, to the electrolytic solution, nitrates, chlorides, amines, aldehydes, phosphoric acid, chromic acid, boric acid, acetic acid, oxalic acid or an aluminum ion.

After electrolytically surface roughened is carried out in the electrolytic solution containing mainly nitric acid, it is preferably dipped in an acid or an aqueous alkali solution in order to remove aluminum dust and the like produced in the surface of the aluminum plate. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the plate surface is preferably 0.5 to 5 g/m². After the plate has been dipped in the aqueous alkali solution, it is preferably dipped in an acid such as phosphoric acid, nitric acid, sulfuric acid and chromic acid, or in a mixed acid thereof, for neutralization.

When electrolytically surface roughening is carried out in an electrolytic solution containing mainly hydrochloric acid, the hydrochloric acid concentration is from 5 to 20 g/liter, and preferably from 6 to 15 g/liter. The current density used is from 15 to 120 A/dm², and preferably from 20 to 90 A/dm². The quantity of electricity is from 400 to 2000 C/dm², and preferably from 500 to 1200 C/dm². The frequency is preferably from 40 to 150 HZ. The temperature during the electrolytically surface roughening is from 10 to 50° C., and preferably from 15 to 45° C. It is possible to optionally add, to the electrolytic solution, nitrates, chlorides, amines, aldehydes, phosphoric acid, chromic acid, boric acid, acetic acid, oxalic acid or an aluminum ion.

After electrolytically surface roughened is carried out in the electrolytic solution containing mainly hydrochloric acid, it is preferably dipped in an acid or an aqueous alkali solution in order to remove aluminum dust and the like produced in the surface of the aluminum plate. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the plate surface is preferably 0.5 to 5 g/m². After the plate has been dipped in the aqueous alkali solution, it is preferably dipped in an acid such as phosphoric acid, nitric acid, sulfuric acid and chromic acid, or in a mixed acid thereof, for neutralization.

The surface on a light sensitive layer side of the aluminum plate obtained above has an arithmetic average roughness (R^{a}) of preferably from 0.4 to 0.6 μm. The surface roughness can be controlled by an appropriate combination of hydrochloric acid concentration, current density and quantity of electricity in surface roughening.

After the surface roughening, anodizing treatment is carried out to form an anodization film on the surface of the plate. In the invention, the anodizing treatment is preferably carried out in a sulfuric acid electrolyte solution or an electrolyte solution containing mainly sulfuric acid. The sulfuric acid concentration is preferably from 5 to 50% by weight, and more preferably from 10 to 35% by weight. The temperature during the anodizing treatment is preferably from 10 to 50° C. The voltage applied is preferably not less than 18V. The current density used is preferably from 1 to 30 A/dm². The quantity of electricity is preferably from 20 to 600 C/dm².

The coated amount of the formed anodization film is preferably from 2 to 6 g/m², and preferably 3 to 5 g/m². The coated amount of the formed anodization film can be obtained from the weight difference between the aluminum plates before and after dissolution of the anodization film. The anodization film of the aluminum plate is dissolved employing for example, an aqueous phosphoric acid chromic acid solution which is prepared by dissolving 35 ml of 85% by weight phosphoric acid and 20 g of chromium (IV) oxide in 1 liter of water. The micro pores are formed in the anodization film, and the micro pore density is preferably from 400 to 700/μm², and more preferably from 400 to 600 μm².

The aluminum plate, which has been subjected to anodizing treatment, is optionally subjected to sealing treatment. For the sealing treatment, it is possible to use known methods using hot water, boiling water, steam, a sodium silicate solution, an aqueous dichromate solution, a nitrite solution and an ammonium acetate solution.

### <Hydrophilization Processing>

After the above treatments, the resulting aluminum plate is preferably subjected to hydrophilization processing in chemical resistance and sensitivity.

The hydrophilization processing method is not specifically limited, but there is a method of undercoating, on a support, a water soluble resin such as polyvinyl phosphonic acid, polyvinyl alcohol or its derivatives, carboxymethylcellulose, dextrin or gum arabic; phosphonic acids with an amino group such as 2-aminoethylphosphonic acid; a polymer or copolymer having a sulfonic acid in the side chain; polyacrylic acid; a water soluble metal salt such as zinc borate; a yellow dye; an amine salt; and so on.

The sol-gel treatment support disclosed in Japanese Patent O.P.I. Publication No. 5-304358, which has a functional group capable of causing addition reaction by radicals as a covalent bond, is suitably used. It is preferred that the support is subjected to hydrophilization processing employing polyvinyl phosphonic acid.

As the processing method, there is for example, a coating method, a spraying method or a dipping method. The solution used in the dipping method is preferably an aqueous 0.05 to 3% polyvinyl phosphonic acid solution. The dipping method is preferred in that the facility is cheap. The temperature is preferably from 20 to 90° C., and the processing time is preferably from 10 to 180 seconds. more preferably 40 to 80° C. After the processing, excessive polyvinyl phosphonic acid is removed from the support surface preferably through washing or squeegeeing. After that, drying is preferably carried out.

The drying temperature is preferably from 40 to 180° C., and more preferably from 50 to 150° C. The drying is preferred in increasing adhesion of the hydrophilization processing layer to the support, improving insulating function of the hydrophilization processing layer, and increasing chemical resistance and sensitivity.

The dry thickness of the hydrophilization processing layer is preferably from 0.002 to 0.1 μm, and more preferably from 0.005 to 0.05 μm in view of adhesion to the support, heat insulating property, and sensitivity.

### (Alkali Soluble Resin)

The alkali soluble resin in the invention refers to a resin which dissolves in an amount of not less than 0.1 g/liter in a 25° C. aqueous potassium hydroxide solution with a pH of 13.

As the alkali soluble resins, a phenolic hydroxyl group-containing resin, an acryl resin or an acetal resin is preferably used in view of ink receptivity or alkali solubility.

The alkali soluble resins can be used singly or an admixture of two or more kinds thereof. An alkali soluble resin used in the lower layer is preferably an acryl resin or an acetal resin in view of alkali solubility, and an alkali soluble resin used in the upper layer is preferably a phenolic hydroxyl group-containing resin, and more preferably novolak resin in view of ink receptivity.

### (Phenolic Hydroxyl Group-Containing Resin)

As the phenolic hydroxyl group-containing resin, there is mentioned a novolak resin which is prepared by condensation of various phenols with aldehydes.

Examples of the phenols include phenol, m-cresol, p-cresol, a mixed cresol (mixture of m- and p-cresols), a mixture of phenol and cresol (m-cresol, p-cresol or a mixture of m- and p-cresols), pyrogallol, acrylamide having a phenolic hydroxyl group, methacrylamide having a phenolic hydroxyl group, acrylate having a phenolic hydroxyl group, methacrylate having a phenolic hydroxyl group, and hydroxyl styrene.

Other examples of the phenols include substituted phenols such as iso-propylphenol, t-butylphenol, t-amylphenol, hexylphenol, cyclohexylphenol, 3-methyl-4-chloro-6-t-butylphenol, iso-propylcresol, t-butylcresol, and t-amylcresol. Preferred phenols are t-butylphenol and t-butylcresol. Examples of the aldehydes include aliphatic aldehydes such as formaldehyde, acetaldehyde, acrolein and crotonaldehyde; and aromatic aldehydes. Formaldehyde and acetaldehyde are preferred, and formaldehyde is especially preferred.

The preferred examples of the novolak resins include phenol-formaldehyde resin, m-cresol-formaldehyde resin, p-cresol-formaldehyde resin, m-/p-cresol (mixed cresol)-formaldehyde resin, and phenol-cresol (m-cresol, p-cresol, o-cresol, m-/p-cresol (mixed), m-/o-cresol (mixed) or o-/p-cresol (mixed))-formaldehyde resin. Especially preferred is m-/p-cresol (mixed cresol)-formaldehyde resin.

It is preferred that the novolak resin has a weight average molecular weight of not less than 1,000, and a number average molecular weight of not less than 200. It is more preferred that the novolak resin has a weight average molecular weight of from 1,500 to 300,000, a number average molecular weight of from 300 to 250,000, and a polydispersity (weight average molecular weight/number average molecular weight) of from 1.1 to 10. It is still more preferred that the novolak resin has a weight average molecular weight of from 2,000 to 10,000, a number average molecular weight of from 500 to 10,000, and a polydispersity (weight average molecular weight/number average molecular weight) of from 1.1 to 5. In the above molecular weight range, layer strength, alkali solubility, anti-chemical properties and interaction between the novolak resin and a light-to-heat conversion material of a layer containing the novolak resin can be suitably adjusted. The weight average molecular weight of novolak resin contained in the upper or lower layer can be also adjusted. Since the chemical resistance and layer strength is required to be high in the upper layer, the weight average molecular weight of novolak resin contained in the upper layer is preferably relatively high, and preferably from 2,000 to 10,000.

The molecular weight of the novolak resin is determined in terms of polystyrene employing monodisperse standard polystyrene according to GPC (gel permeation chromatography).

The novolak resin in the invention can be synthesized according to a method disclosed in for example, “Shi Jikken Kagaku Koza [19] Polymer Chemistry [1]”, published by Maruzen Shuppan, p. 300 (1993). That is, phenol or substituted phenols (for example, xylenol or cresol) is dissolved in a solvent, mixed with an aqueous formaldehyde solution, and reacted in the presence of an acid, in which dehydration condensation reaction occurs at the ortho or para position of the phenol or substituted phenols to form a novolak resin. The resulting novolak resin is dissolved in an organic solvent, then mixed with a non-polar solvent and allowed to stand for several hours. The novolak resin mixture forms two phases separated, and the lower phase is concentrated, whereby a novolak resin with a narrow molecular weight distribution is obtained.

The organic solvent used is acetone, methyl alcohol or ethyl alcohol. The non-polar solvent used is hexane or petroleum ether. Further, the synthetic method is not limited to the above. As is disclosed in for example, Japanese Patent O.P.I. Publication No. 2001-506294, the novolak resin is dissolved in a water-soluble organic polar solvent, and then mixed with water to obtain precipitates, whereby a fraction of the novolak resin can be obtained. Further, As a method to obtain a novolak resin with a narrow molecular weight distribution, there is a method in which a novolak resin obtained by dehydration condensation is dissolved in an organic solvent and the resulting solution is subjected to silica gel chromatography for molecular weight fractionation.

Dehydration condensation of phenol with formaldehyde or dehydration condensation of substituted phenols with formaldehyde at o- or p-position of the substituted phenols is carried out as follows:

Phenol or substituted phenols are dissolved in a solvent to obtain a solution having a phenol or substituted phenol concentration of from 60 to 90% by weight, and preferably from 60 to 90% by weight. Then, formaldehyde is added to the resulting solution so that the concentration ratio (by mole) of the formaldehyde to the phenol or substituted phenol is from 0.2 to 2.0, preferably from 0.4 to 1.4, and more preferably from 0.6 to 1.2, and further acid catalyst is added at a reaction temperature of from 10 to 150° C. so that the concentration ratio (by mole) of the acid catalyst to the phenol or substituted phenol is from 0.01 to 0.1, and preferably from 0.02 to 0.05. The resulting mixture is stirred for several hours while maintaining that temperature range. The reaction temperature is preferably from 70 to 150° C., and more preferably from 90 to 140° C.

The novolak resin can be used singly or as a mixture of two or more kinds thereof. A combination of two or more kinds of novolak resin makes it possible to effectively provide various properties such as layer strength, alkali solubility, anti-chemical properties and interaction between the novolak resin and a light-to-heat conversion material. When two or more kinds of novolak resin are used in the image formation layer, the weight average molecular weight or m/p ratio difference between them is preferably great. For example, the weight average molecular weight difference between the two or more kinds of novolak resins is preferably not less than 1000, and more preferably not less than 2000, and the m/p ratio difference between the two or more kinds of novolak resins is preferably not less than 0.2, and more preferably not less than 0.3.

The phenolic hydroxyl group-containing resin content of the upper layer in the planographic printing plate material of the invention is preferably from 30 to 99% by weight, more preferably from 45 to 95% by weight, and still more preferably from 60 to 90% by weight, based on the total weight of the upper layer, in view of chemical resistance or printing durability.

### (Acryl Resin)

The acryl resin is preferably a copolymer containing a constituent unit derived from other monomers in addition to a constituent unit derived from (meth)acrylates. Examples of the other monomers include (meth)acrylamides, vinyl esters, styrenes, (meth)acrylic acid, acrylonitrile, maleic anhydride, maleic imide, and lactones.

Examples of the acrylates include methyl acrylate, ethyl acrylate, (n- or i-)propyl acrylate, (n-, i- or sec- or tert-)butyl acrylate, amyl acrylate, 2-ethylhexyl acrylate, dodecyl acrylate, 2-chloroethyl acrylate, 2-hydroxyethyl acrylate, 2-hydroxypropyl acrylate, 5-hydroxypentyl acrylate, cyclohexyl acrylate, allyl acrylate, trimethylpropane monoacrylate, pentaerythritol monoacrylate, glycidyl acrylate, benzyl acrylate, chlorobenzyl acrylate, 2-(p-hydroxyphenyl)ethyl acrylate, furfuryl acrylate, tetrahydrofurfuryl acrylate, phenyl acrylate, chlorophenyl acrylate, and sulfamoylphenyl acrylate.

Examples of the methacrylates include methyl methacrylate, ethyl methacrylate, (n- or i-)propyl methacrylate, (n-, i- or sec- or tert-)butyl methacrylate, amyl methacrylate, 2-ethylhexyl methacrylate, dodecyl methacrylate, 2-chloroethyl methacrylate, 2-hydroxyethyl methacrylate, 2 hydroxypropyl methacrylate, 5-hydroxypentyl methacrylate, cyclohexyl methacrylate, allyl methacrylate, trimethylpropane monomethacrylate, pentaerythritol monomethacrylate, glycidyl methacrylate, benzyl methacrylate, chlorobenzyl methacrylate, 2-(p-hydroxyphenyl)ethyl methacrylate, furfuryl methacrylate, tetrahydrofurfuryl methacrylate, phenyl methacrylate, chlorophenyl methacrylate, and sulfamoylphenyl methacrylate.

Examples of acrylamides include acrylamide, N-methyl acrylamide, N-ethyl acrylamide, N-propyl acrylamide, N-butyl acrylamide, N-benzyl acrylamide, N-hydroxyethyl acrylamide, N-phenyl acrylamide, N-tolyl acrylamide, N-(p-hydroxyphenyl) acrylamide, N-(sulfamoylphenyl)acrylamide, N-(phenylsulfonyl)acrylamide, N-(tolylsulfonyl)acrylamide, N,N-dimethyl acrylamide, N-methyl-N-phenyl acrylamide, N-hydroxyethyl-N-methyl acrylamide, and N-(p-toluenrsulfonyl)acrylamide.

Examples of methacrylamides include methacrylamide, N-methyl methacrylamide, N-ethyl methacrylamide, N-propyl methacrylamide, N-butyl methacrylamide, N-benzyl methacrylamide, N-hydroxyethyl methacrylamide, N-phenyl methacrylamide, N-tolyl methacrylamide, N-(p-hydroxyphenyl)methacrylamide, N-(sulfamoylphenyl)methacrylamide, N-(phenylsulfonyl)methacrylamide, N-(tolylsulfonyl)methacrylamide, N,N-dimethyl methacrylamide, N-methyl-N-phenyl methacrylamide, N-hydroxyethyl-N-methyl methacrylamide, and N-(p-toluenrsulfonyl)methacrylamide.

Examples of lactones include pantoyl lactone (meth)acrylate, α-(meth)acryloyl-γ-butyrolactone, and β-(meth)acryloyl-γ-butyrolactone.

Examples of maleic imides include meleimide, N-acryloyl acrylamide, N-acetyl methacrylamide, N-propyl methacrylamide, and N-(p-chlorobenzoyl)methacrylamide.

Examples of vinyl ester include vinyl acetate, vinyl butyrate, and vinyl benzoate.

Examples of styrenes include styrene, methylstyrene, dimethylstyrene, trimethylstyrene, ethylstyrene, propylstyrene, cyclohexylstyrene, chloromethylstyrene, trifluoromethylstyrene, ethoxystyrene, acetoxystyrene, methoxystyrene, dimethoxystyrene, chlorostyrene, dichlorostyrene, bromostyrene, iodostyrene, fluorostyrene, and carboxystyrene.

Examples of acrylonitriles include acrylonitrile and methacrylonitrile.

Among these monomers, acrylates or methacrylates having a carbon atom number of not more than 20, acrylamides, methacrylamides, acrylic acid, methacrylic acid, acrylonitriles, or maleic imides are preferably used.

The weight average molecular weight Mw of the acryl resin or the modified acryl resin in the invention is preferably not less than 2000, more preferably from 5000 to 100000, and still more preferably from 10000 to 50000. The above molecular weight range makes it possible to adjust layer strength, alkali solubility, or chemical resistance of the layer, whereby the advantageous effects of the invention are easily obtained.

In the invention, the acryl resins may be in the form of random polymer, blocked polymer, or graft polymer, and is preferably a blocked polymer capable of separating a hydrophilic group from a hydrophobic group, in that it can adjust solubility to a developer.

The acryl resins in the invention may be used singly or as a mixture of two or more kinds thereof.

### (Acetal Resin)

The polyvinyl acetal resins used in the invention can be synthesized by acetalyzing polyvinyl alcohol with aldehydes and reacting the residual hydroxyl group with acid anhydrides.

Examples of the aldehydes include formaldehyde, acetaldehyde, propionaldehyde, butylaldehyde, pentylaldehyde, hexylaldehyde, glyoxalic acid, N,N-dimethylformamide, di-n-butylacetal, bromoacetaldehyde, chloroaldehyde, 3-hydroxy-n-butylaldehyde, 3-methoxy-n-butylaldehyde, 3-dimethylamino-2,2-dimethylpropionaldehyde, and cyanoacetaldehyde. In the invention, the aldehyde are not limited thereto.

The acetal resin in the invention is preferably a polyvinyl acetal resin represented by the following formula (3):

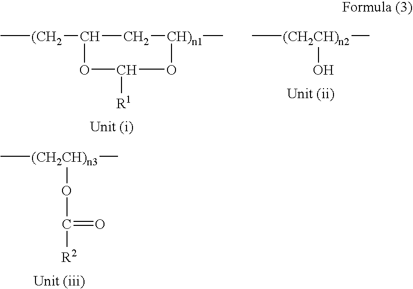

In formula (3), n1 represents 5 to 85 mol %, n2 represents 0 to 60 mol %, and n3 represents 0 to 60 mol %.

The unit (i) is a group derived from vinyl acetal, the unit (ii) is a group derived from vinyl alcohol, and the unit (iii) is a group derived from vinyl ester.

In unit (1), R¹ represents a hydrogen atom, a substituted or unsubstituted alkyl group, an aryl group, a carboxyl group or a dimethylamino group.

Examples of the substituent include a carboxyl group, a hydroxyl group, a chlorine atom, a bromine atom, a urethane group, a ureido group, a tertiary amino group, an alkoxy group, a cyano group, a nitro group, an amido group, and an ester group. Examples of R¹ include a hydrogen atom, a methyl group, an ethyl group, a propyl group, a butyl group, a pentyl group, a carboxyl group, a halogen atom (—Br or Cl), a cyanomethyl group, 3-hydroxybutyl group, 3-methoxybutyl group and a phenyl group.

In unit (i), n1 represents 5 to 85% by mole, and preferably 25 to 75% by mole. The above range of n1 is advantageous in layer strength, printing durability or solubility to a solvent for coating.

In unit (ii), n2 represents 0 to 60% by mole, and preferably from 10 to 45% by mole. The unit (ii) is a unit having great affinity to water. The above range of n2 is advantageous in printing durability.

In unit (iii), R² represents an unsubstituted alkyl group, an aliphatic hydrocarbon group having a carboxyl group, an alicyclic group, or an aromatic hydrocarbon group. The hydrocarbon groups have a carbon atom number of from 1 to 20. R² is preferably an alkyl group having a carbon atom number of from 1 to 10, and more preferably a methyl group or an ethyl group. In unit (iii), n3 represents 0 to 20% by mole, and preferably from 1 to 10% by mole. The above range of n3 is advantageous in printing durability.

The acid content of the polyvinyl acetal resin in the invention is preferably from 0.5 to 5.0 meq/g (from 84 to 280 in terms of acid value), and more preferably from 0.1 to 3.0 meq/g. The above acid content range is preferred in sensitivity and development latitude.

The weight average molecular weight of the polyvinyl acetal resin in the invention is preferably from about 20000 to 3000000, and more preferably from about 5000 to 4000000, being measured according to gel permeation chromatography. The above molecular weight range makes it possible to adjust layer strength, alkali solubility, or chemical resistance of the layer, whereby the advantageous effects of the invention are easily obtained.

These polyvinyl acetal resins may be used singly or as a mixture of two or more kinds thereof.

The acetalyzation of polyvinyl alcohol can be carried out according to conventional methods disclosed in for example, U.S. Pat. Nos. 4,665,124, 4,940,646, 5,169,898, 5,700,619, and 5,792,823, and Japanese Patent No. 09328519.

### (Fluoroalkyl Group-Containing Acryl Resin)

The fluoroalkyl group-containing acryl resin is a homopolymer or copolymer having a monomer unit having a fluoroalkyl group.

The fluoroalkyl group-containing acryl resin is preferably a resin which is obtained by polymerization of a monomer represented by formula (4) below, and more preferably a copolymer comprising as a comonomer unit a monomer unit derived from that monomer

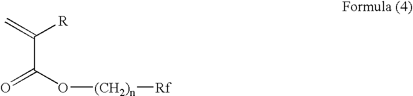

In formula (4), Rf represents a fluoroalkyl group (for example, a perfluoroalkyl group) having a fluorine atom number of not less than 3 or a substituent with a fluoroalkyl group (for example, a perfluoroalkyl group) having a fluorine atom number of not less than 3; n is 1 or 2; and R represents a hydrogen atom or an alkyl group having a carbon atom number of from 1 to 4. R^{f} is, for example, —CₘF₂ₘ₊₁ or (CF₂)ₘH (in which m is an integer of from 4 to 12).

The fluoroalkyl group having a fluorine atom number of not less than 3 or perfluoroalkyl group lowers the heat transfer coefficient of the layer and minimizes exposure unevenness resulting from kinds of an exposure device, resulting in high productivity.

The fluorine atom number per the monomer unit is preferably not less than 3, more preferably not less than 6, and still more preferably not less than 9.

The above-described fluorine atom number range locates the fluoroalkyl group-containing acryl resin on the surface of the layer, resulting in excellent ink receptivity.

The fluorine atom content of the fluoroalkyl group-containing acryl resin is preferably from 5 to 30 mmol/g, and more preferably from 8 to 25 mmol/g, in view of surface orientation of the resin, and balance between the developability and ink receptivity.

The comonomer unit in the copolymer having a fluoroalkyl group is derived from the comonomer used in preparation of the acryl resin as described above. Examples of the comonomer include acrylate, methacrylate, acrylamide, methacrylamide, styrene and a vinyl monomer. Acrylate, methacrylate, acrylamide, or methacrylamide is especially preferred.

The average molecular weight of the fluoroalkyl group-containing acryl resin is preferably from 3000 to 200000, and more preferably from 6000 to 100000.

The content of the fluoroalkyl group-containing acryl resin in the upper or lower layer is preferably from 0.01 to 50% by weight, more preferably from 0.1 to 30% by weight, and still more preferably from 1 to 15% by weight, in view of image uniformity, sensitivity and development latitude.

Typical examples of the fluoroalkyl group-containing acryl resin will be listed below. The numerical numbers in the following formulae represent mol % of the monomer units.

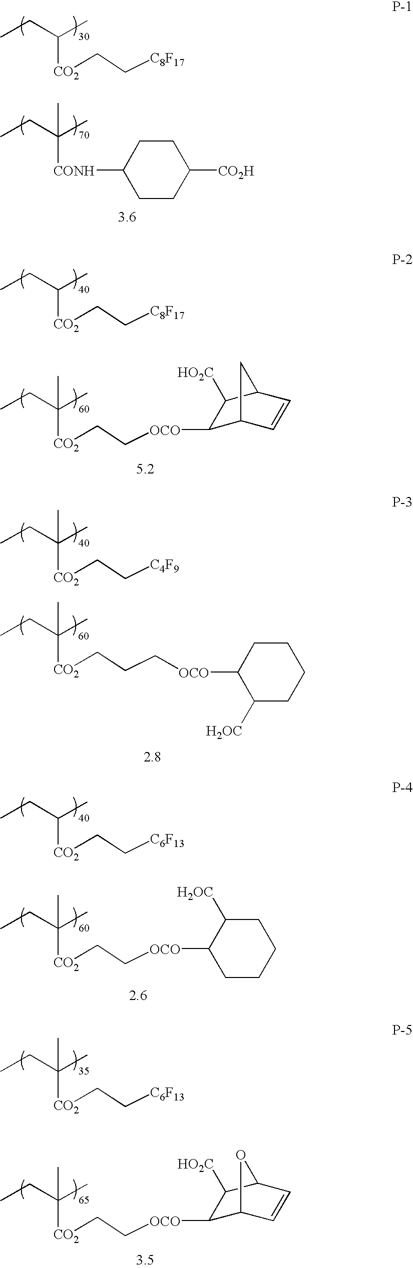

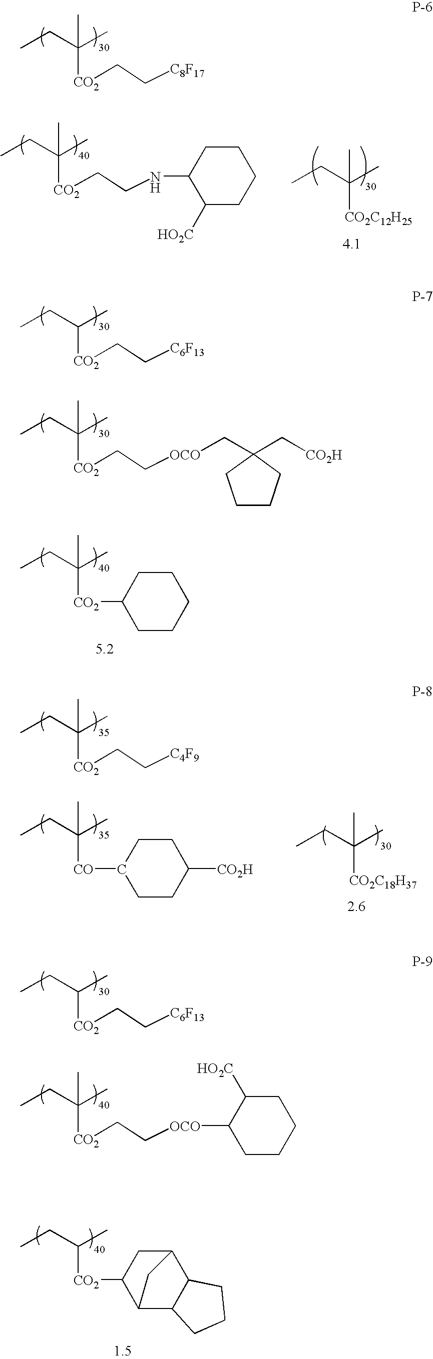

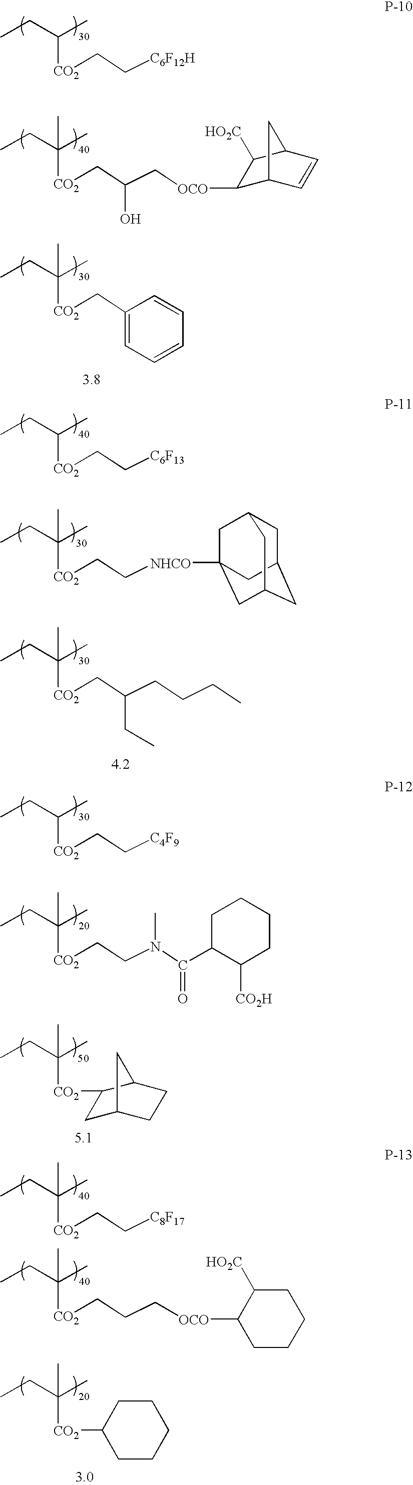

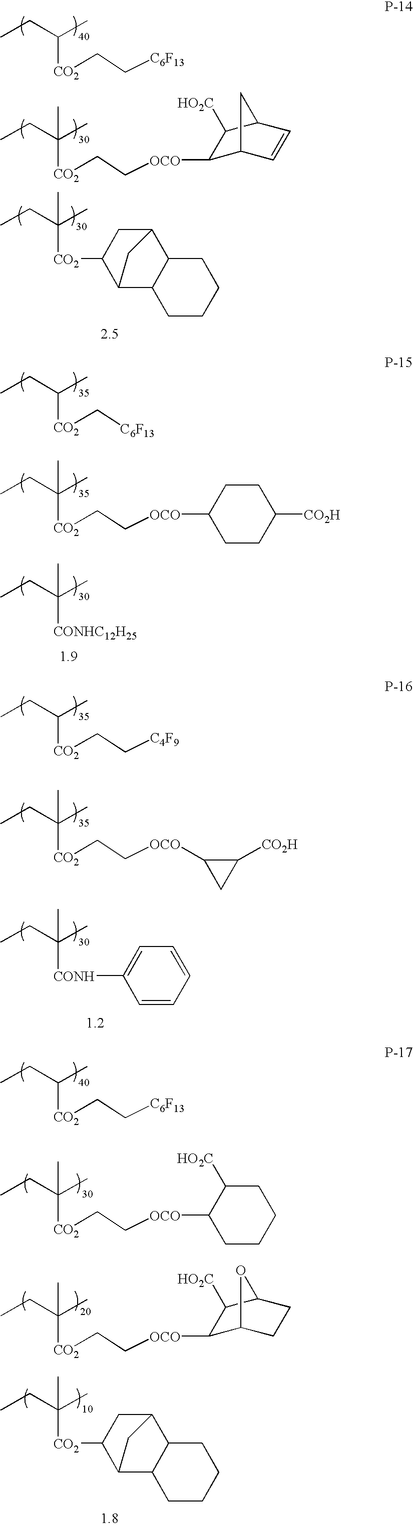

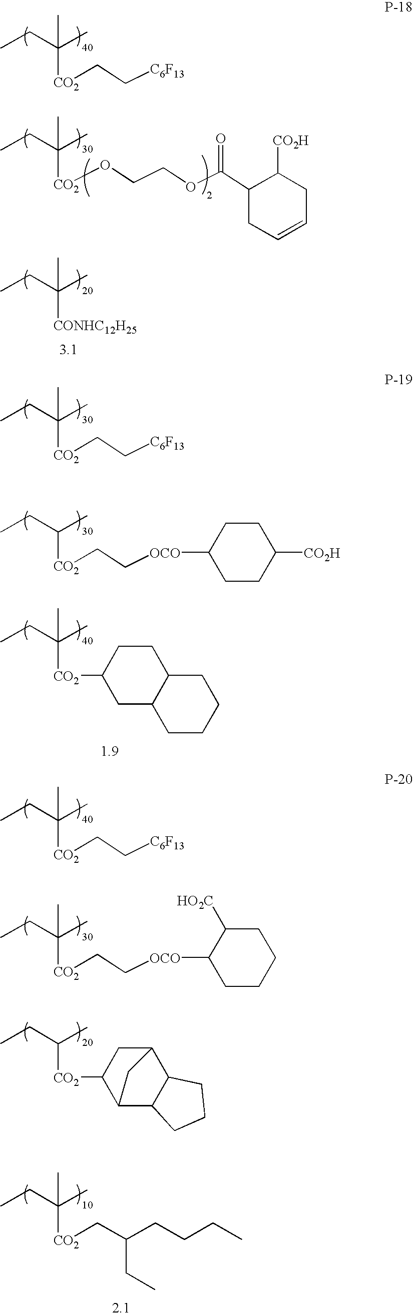

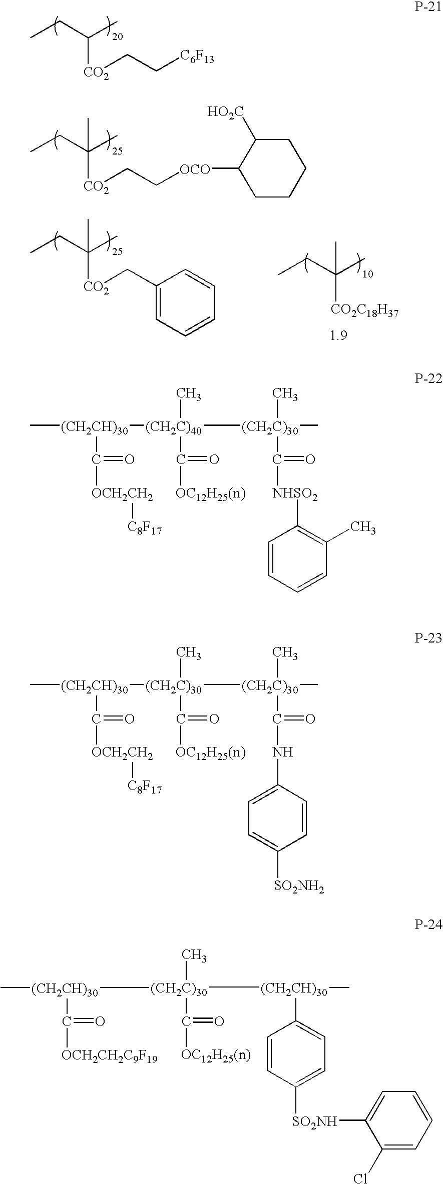

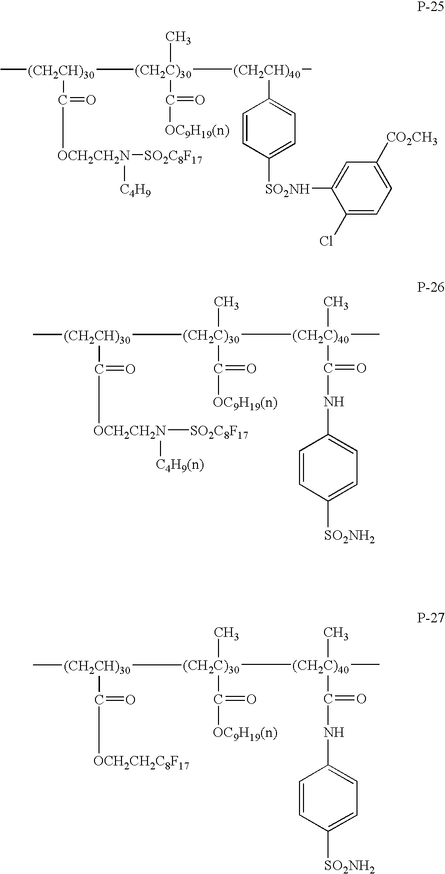

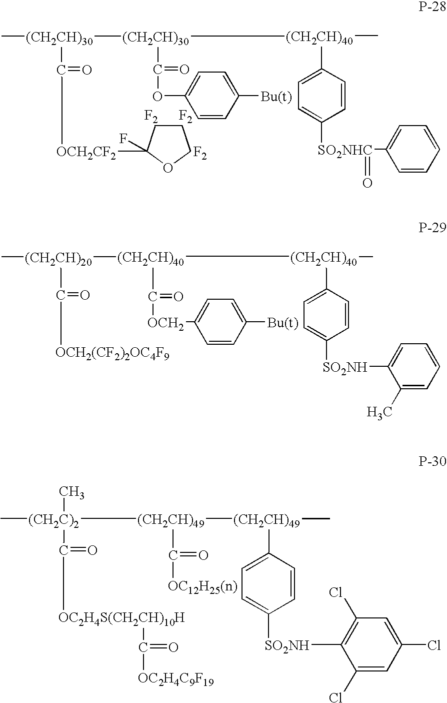

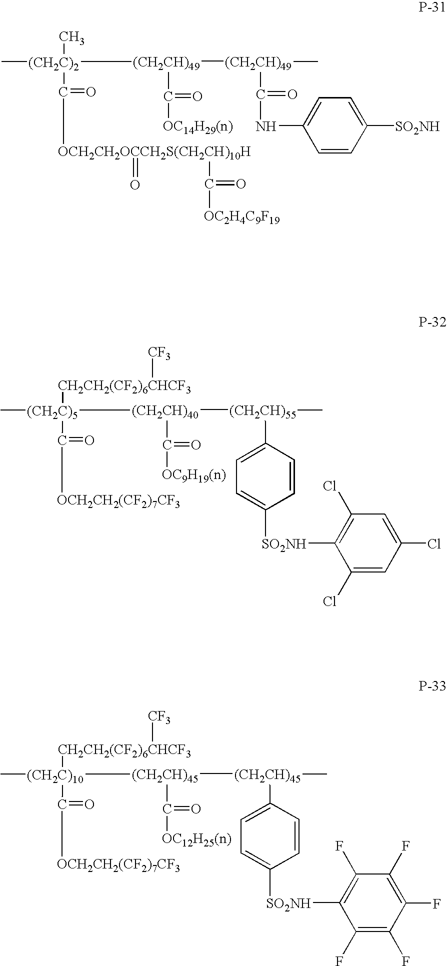

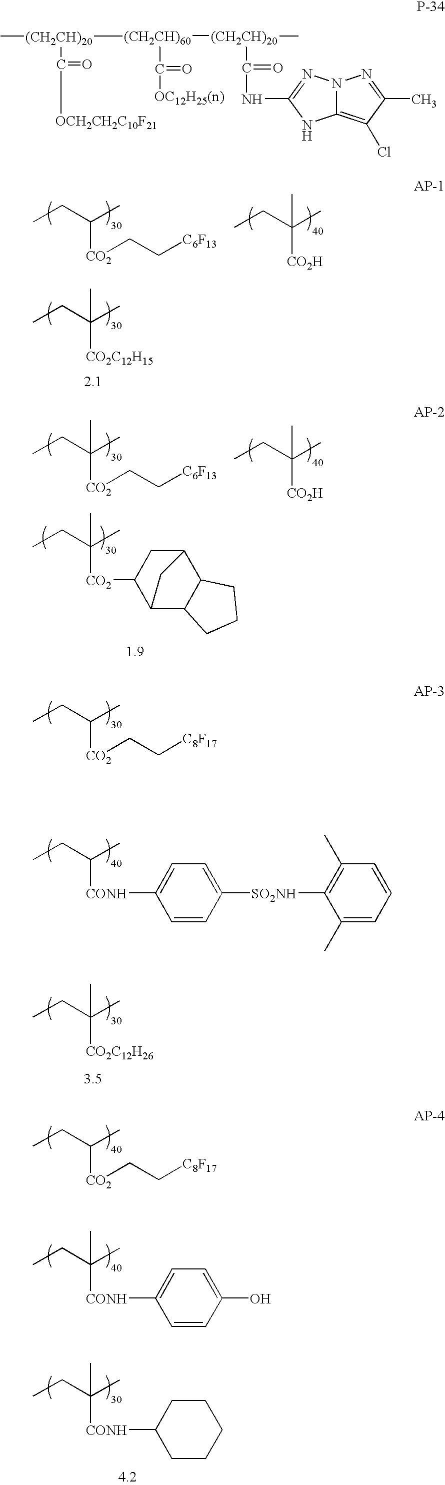

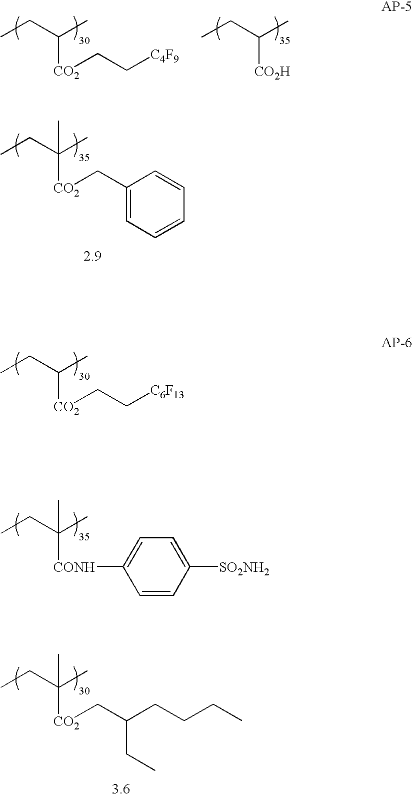

The action of the fluoroalkyl group-containing acryl resin in the invention is not clear, but it is assumed that in a planographic printing plate material comprising a support and provided thereon a lower layer and an upper layer in the order, each layer containing an alkali soluble resin, incorporation an acid decomposable compound or an acid generating agent in the lower layer improves sensitivity and development latitude. Further, it is assumed that incorporation of a fluoroalkyl group-containing acryl resin in at least one of the upper and lower layers lowers the heat transfer coefficient and a combined use of the fluoroalkyl group-containing acryl resin and an acid decomposable compound or an acid generating agent lowers heat transfer at portions at the vicinity of exposed portions, which results in high productivity and an image with high precision and uniformity. Thus, the present invention provides a light sensitive planographic printing plate material which excels in all of image uniformity, sensitivity, development latitude and chemical resistance.

### (Light-to-Heat Conversion Material)

The light-to-heat conversion material used in the invention refers to a compound having an absorption band in the infrared wavelength regions of from not shorter than 700 nm, and preferably from 750 to 1200 nm, and converting the light with those wavelength regions to heat, and typically pigment or a dye generating heat on absorption of light with those wavelength regions.

### (Pigment)

As pigment commercially available pigments and pigments described in Color Index (C.I.) Binran, “Saishin Ganryo Binran” (ed. by Nihon Canryo Gijutsu Kyokai, 1977), “Saishin Ganryo Oyo Gijutsu” (CMC Publishing Co., Ltd., 1986), and “Insatsu Inki Gijutsu” (CMC Publishing Co., Ltd., 1984) can be used.

Kinds of the pigment include black pigment, yellow pigment, orange pigment, brown pigment, red pigment, violet pigment, blue pigment, green pigment, fluorescent pigment, metal powder pigment, and metal-containing colorants. Typical examples of the pigment include insoluble azo pigment, azo lake pigment, condensed azo pigment, chelate azo pigment, phthalocyanine pigment, anthraquinone pigment, perylene or perynone pigment, thioindigo pigment, quinacridone pigment, dioxazine pigment, isoindolinone pigment, quinophthalone pigment, lake pigment, azine pigment, nitroso pigment, nitro pigment, natural pigment, fluorescent pigment, inorganic pigment, and carbon black.

The particle size of the pigment is preferably from 0.01 to 10 μm, more preferably from 0.05 to 1 μm, and still more preferably from 0.1 to 1 μm.

As a dispersion method of pigments, a conventional dispersion method used in manufacture of printing ink or toners can be used. Dispersion devices include an ultrasonic disperser, a sand mill, an atliter, a pearl mill, a super mill, a ball mill, an impeller, a disperser, a KD mill, a colloid mill, a dynatron, a three-roll mill, and a pressure kneader. The details are described in “Saishin Ganryo Oyou Gijutsu” (CMC Publishing Co., Ltd., 1986).

The pigment content of the upper layer in the invention is preferably from 0.01 to 10% by weight, and more preferably from 0.1 to 5% by weight, in view of uniformity and durability of light sensitive layer, and sensitivity.

### (Dyes)

As the dyes, well-known dyes, i.e., commercially available dyes or dyes described in literatures (for example, “Senryo Binran”, edited by Yuki Gosei Kagaku Kyokai, published in 1970) can be used. Examples thereof include azo dyes, metal complex azo dyes, pyrazoline azo dyes, anthraquinone dyes, phthalocyanine dyes, carbonium dyes, quinonimine dyes, methine dyes, and cyanine dyes. Among these dyes or pigments, dyes absorbing an infrared light or a near-infrared light are preferred in that a laser emitting an infrared light or a near-infrared light can be employed. Examples of the dyes absorbing an infrared light or a near-infrared light include cyanine dyes disclosed in Japanese Patent O.P.I. Publication Nos. 58-125246, 59-84356, and 60-78787, methine dyes disclosed in Japanese Patent O.P.I. Publication Nos. 58-1736696, 58-181690, and 58-194595, naphthoquinone dyes disclosed in Japanese Patent O.P.I. Publication Nos. 58-112793, 58-224793, 59-48187, 59-73996, 60-52940, and 60-63744, squarylium dyes disclosed in Japanese Patent O.P.I. Publication Nos. 58-112792, and cyanine dyes disclosed in British Patent No. 434,875. Further, near infrared absorbing sensitizing dyes described in U.S. Pat. No. 5,156,938 are suitably employed as the dyes. In addition, preferably employed are substituted arylbenzo(thio)pyrylium salts described in U.S. Pat. No. 3,881,924; trimethine-thiapyrylium salts described in Japanese Patent O.P.I. Publication No. 57-142645 (U.S. Pat. No. 4,327,169); pyrylium based compounds described in Japanese Patent O.P.I. Publication Nos. 58-181051, 58-220143, 59-41363, 59-84248, 59-84249, 59-146063, and 59-146061; cyanine dyes described in Japanese Patent O.P.I. Publication No. 59-216146; pentamethinethiopyrylium salts described in U.S. Pat. No. 4,283,475; pyrylium compounds described in Japanese Patent Publication No. 5-13514 and 5-19702, and Epolight III-178, Epolight III-130 or Epolight III-125.

Of these dyes, particularly preferred dyes are cyanine dyes, phthalocyanine dyes, oxonol dyes, squarylium dyes, pyrylium dyes, thiopyrylium dyes, and nickel thiolato complexes. A cyanine dye represented by formula (a) is most preferred in providing high interaction with the alkali soluble resin, excellent stability and excellent economical performance.

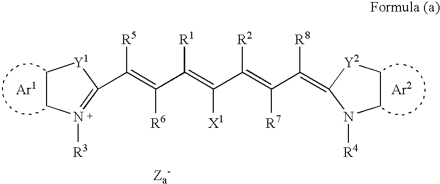

In formula (a), X¹ represents a hydrogen atom, a halogen atom, -Nph₂, X²-L¹, in which X² represents an oxygen atom or a sulfur atom, and L¹ represents a hydrocarbon group having a carbon atom number of from 1 to 12, a hetero atom-containing aromatic ring group or a hetero atom-containing hydrocarbon group having a carbon atom number of from 1 to 12, or a group represented by formula (b):

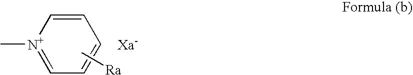

wherein Xa⁻ represents the same as Za⁻ described later; Ra represents a hydrogen atom, an alkyl group, an aryl group, a substituted or unsubstituted amino group, or a halogen atom.

The hetero atom herein referred to is N, S, O, a halogen atom, or Se.

R¹ and R² independently represent a hydrocarbon group having a carbon atom number of from 1 to 12, provided that R¹ and R² may combine with each other to form a 5- or 6-membered ring.

Ar¹ and Ar² independently represent a substituted or unsubstituted aromatic hydrocarbon group, and may be the same or different.

Preferred examples of the (unsubstituted) aromatic hydrocarbon groups include a phenyl group or a naphthyl group, and preferred examples of the substituent include a hydrocarbon group having a carbon atom number of not more than 12, a halogen atom or an alkoxy group having a carbon atom number of not more than 12. Y¹ and Y² independently represent a sulfur atom or a diaklylmethylene group having a carbon atom number of not more than 12, and may be the same or different R³ and R⁴ independently represent a substituted or unsubstituted hydrocarbon group having a carbon atom number of not more than 20, and may be the same or different. Examples of the substituent include an alkoxy group having a carbon atom number of not more than 12, a carboxyl group or a sulfo group. R⁵, R⁶, R⁷ and R⁸ independently represent a hydrogen atom or a hydrocarbon group having a carbon atom number of not more than 12, and may be the same or different. R⁵, R⁶, R⁷ and R⁸ represent preferably a hydrogen atom in view of availability. Za⁻ represents an anionic group, provided that when the cyanine dye represented by formula (a) forms an intramolecular salt, Za⁻ is not necessary. Preferred examples of Za⁻ include a halogen ion, a perchlorate ion, a tetrafluoroborate ion, a hexafluorophosphate ion, and a sulfonate ion. Especially preferred Za⁻ is a perchlorate ion, a hexafluorophosphate ion, or an arylsulfonate ion.

Typical examples of the cyanine dye represented by formula (a) above will be listed below.

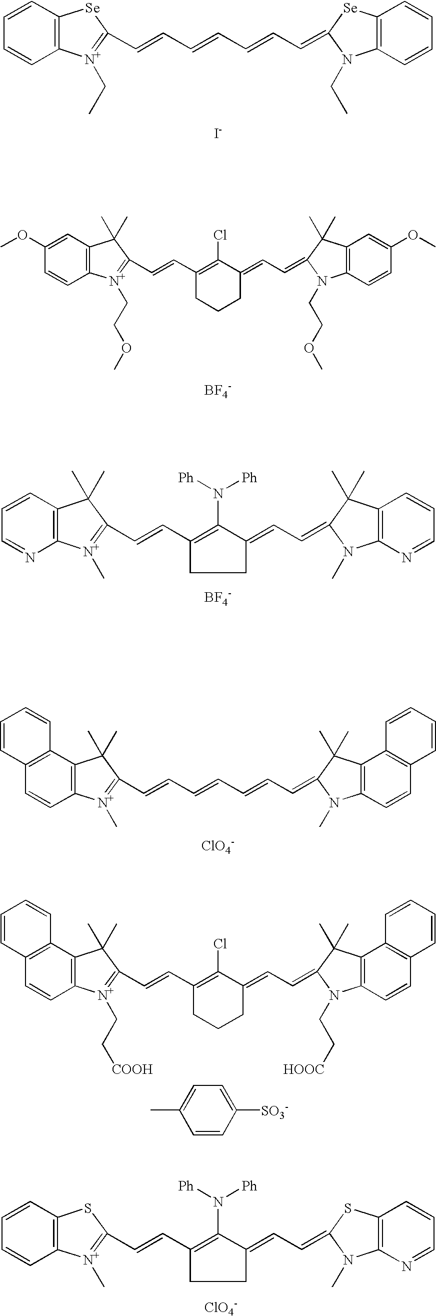

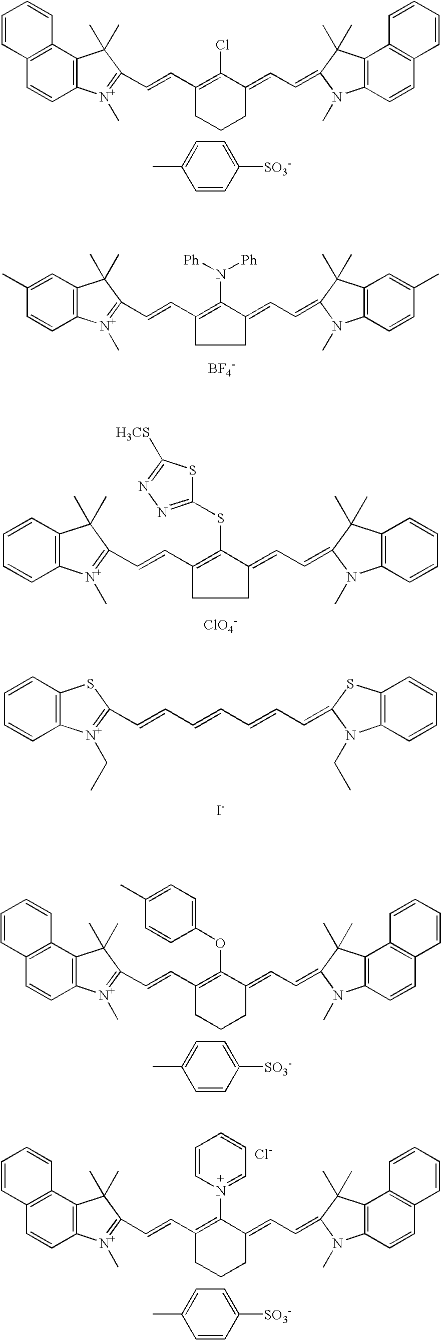

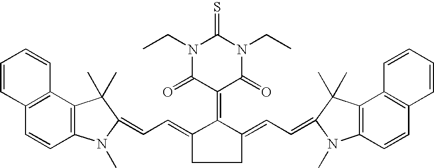

Typical examples of the cyanine dye represented by formula (a) above include ones disclosed in Japanese Patent O.P.I. Publication No. 2001-133969, paragraphs [0017]-[0019], Japanese Patent O.P.I. Publication No. 2002-40638, paragraphs [0012]-[0038], and Japanese Patent O.P.I. Publication No. 2002-23360, paragraphs [0012]-[0023]1, in addition to ones listed above.

The dye content of an upper layer in which the dye is contained is preferably from 0.01 to 30% by weight, more preferably from 0.1 to 10% by weight, and still more preferably from 0.1 to 7% by weight, in view of sensitivity, chemical resistance and printing durability.

### (Acid Decomposable Compound)

The lower layer in the invention contains an acid decomposable compound represented by formula (1) above.

In formula (1), n represents an integer of 1 or more; m represents an integer of 0 or more; X represents a carbon atom or a silicon atom; and R₄ represents an ethyleneoxy group or a propyleneoxy group.

R₂ and R₅ independently represent a hydrogen atom, an alkyl group or an aryl group; R₃ and R₆ independently represent an alkyl group or an aryl group, provided that R₂ and R₃ may combine with each other to form a ring or R₅ and R₆ may combine with each other to form a ring;

R₇ represents an alkylene group; R₁ represents a hydrogen atom, an alkyl group, an aryl group, an alkoxy group, an alkyleneoxy group or a halogen atom; and R₈ represents a hydrogen atom, —XR₂R₃R₁ or —XR₅R₆R₁.

Of the acid decomposable compounds represented by formula (1) above, an acetal is preferred. It is preferred in view of good yield that such an acetal is synthesized by polycondensation of dimethylacetal or diethylacetal derivatives of aldehydes or ketones with diol compounds such as ethylene glycol, diethylene glycol, triethylene glycol, tetraethylene glycol, pentaethylene glycol, polyethylene glycol, propylene glycol, dipropylene glycol, tripropylene glycol, tetrapropylene glycol, pentapropylene glycol, polypropylene glycol, and polyethylene glycol-polypropylene glycol copolymer.

Examples of the aldehydes for preparation of the acetals include acetoaldehyde, chloral, ethoxyacetoaldehyde, benzyloxyacetoaldehyde, phenylacetoaldehyde, diphenylacetoaldehyde, phenoxyacetoaldehyde, propionaldehyde, 2-phenyl or 3-phenylaldehyde, isobutoxypivalic aldehyde, benzyloxypivalic aldehyde, 3-ethoxypropanal, 3-cyanopropanal, n-butanal, isobutanal, 3-chloro-butanal, 3-methoxy-butanal, 2,2-dimethyl-4-cyano-butanal, 2 or 3-ethylbutanal, n-pentanal, 2 or 3-methylpentanal, 2-bromo-3-methylpentanal, 2-hexanal, cyclopentanecarbaldehyde, n-heptanal, cyclohexanecarbaldehyde, 1,2,3,6-tetrahydrobenzaldehyde, 3-ethylpentanal, 3- or 4-methyl-hexanal, n-octanal, 2- or 4-ethylhexanal, 3,5,5-trimethylhexanal, 4-methylheptanal, 3-ethyl-n-heptanal, decanal, dodecanal, crotonaldehyde, benzaldehyde, 2-, 3- or 4-bromobenzaldehyde, 2,4-, or 3,4-dichlorobenzaldehyde, 4-methoxybenzaldehyde, 2,3- or 2,4-dimethoxybenzaldehyde, 2-, 3- or 4-fluorobenzaldehyde, 2-, 3- or 4-methylbenzaldehyde, 4-isopropylbenzaldehyde, 3 or 4-tetrafluoroethoxybenzaldehyde, 1-, or 2-naphthoaldehyde, furfural, thiophene-2-aldehyde, terephthalaldehyde, piperonal, 2-pyridinecarbaldehyde, p-hydroxy-benzaldehyde, 3,4-dihydroxy-benzaldehyde, 5-methyl-furaldehyde and vanillin, Ketones for preparation of the ketals include phenylacetone, 1,3-diphenylacetone, 2,2-diphenylacetone, chloro, or bromoacetone, benzylacetone, methyl ethyl ketone, benzyl propyl ketone, ethylbenzyl ketone, isobutyl ketone, 5-methyl-hexane-2-one, 2-methyl-pentane-2-one, 2-methyl-pentane-3-one, hexane-2-one, pentane-3-one, 2-methyl-butane-3-one, 2,2-dimethyl-butane-3-one, 5-methyl-heptane-3-one, octane-2-one, octane-3-one, nonane-2-one, nonane-3-one, nonane-5-one, heptane-2-one, heptane-3-one, heptane-4-one, undecane-2-one, undecane-4-one, undecane-5-one, undecane-6-one, dodecane-2-one, dodecane-3-one, triecane-2-one, tridecane-3-one, triecane-7-one, dinonyl ketone, dioctyl ketone, 2-methyl-octane-3-one, cyclopropyl methyl ketone, decane-2-one, decane-3-one, decane-4-one, methyl-α-naphthyl ketone, didecyl ketone, diheptyl ketone, dihexyl ketone, acetophenone, 4-methoxy-acetophenone, 4-chloro-acetophenone, 2,4-dimethyl-acetophenone, 2-, 3- or 4-fluoroacetophenone, 2-, 3- or 4-methylacetophenone, 2-, 3- or 4-methoxyacetophenone, propiophenone, 4-methoxy-propiophenone, butyrophenone, valerophenone, benzophenone, 3,4-dihydroxybenzophenone, 2,5-dimethoxybenzophenone, 3,4-dimethoxybenzophenone, 3,4-dimethylbenzophenone, cyclohexanone, 2-phenyl-cyclohexanone, 2-, 3- or 4-methylcyclohexanone, 4-t-butyl-cyclohexanone, 2,6-dimethylcyclohexanone, 2-chloro-cyclohexanone, cyclopentanone, cycloheptanone, cyclooctanone, cyclononanone, 2-cyclohexene-1-one, cyclohexylpropanone, flavanone, cyclohexane-1,4-dione, cyclohexane-1,3-dione, tropone, and isophorone.

The preferable are aldehydes or ketones which have a solubility in 25° C. water of 1 to 100 g/liter. Solubility of less than 1 g/liter is likely to produce sludge while continuously processing, and solubility exceeding 100 g/liter is likely to lower resolving power of formed images. Examples thereof include benzaldehyde, 4-hydroxybenzaldehyde, 3,4-dihydroxybenzaldehyde, 2-pyridinecarbaldehyde, piperonal, phthalaldehyde, terephthalaldehyde, 5-methyl-2-phthalaldehyde, phenoxyacetoaldehyde, phenylacetoaldehyde, cyclohexanecarbaldehyde, vanillin, cyclohexanone, cyclohexene-1-one, isobutylaldehyde, and pentanal. Of these, cyclohexanone is more preferable in view of processing stability.

The silyl ether compound in the invention is synthesized by polycondensation of a silyl compound with the above dial compound.

In the invention, a silyl compound, which forms on decomposition of the silylether compound by an acid, has preferably a solubility in 25° C. water of 1 to 100 g/liter.

Examples of the silyl compound include dichlorodimethyl silane, dichlorodiethyl silane, methylphenyldichloro silane, diphenyldichloro silane, and methylbenzyldichloro silane.

The above described acetal compounds or silylether compounds can be synthesized also by copolycondensation using the above diol compounds and alcohol components other than the diol compounds. Examples of the alcohol components include substituted or unsubstituted monoalkyl alcohols such as methanol, ethanol, n-propanol, isopropanol, butanol, pentanol, hexanol, cyclohexanol, and benzyl alcohol; glycol ethers such as ethylene glycol monomethylether, ethylene glycol monoethylether, ethylene glycol monomphenylether, diethylene glycol monomethylether, diethylene glycol monoethylether, diethylene glycol monophenylether, and substituted or unsubstituted polyethylene glycol alkylethers or polyethylene glycol phenylethers Examples of dihydric alcohols include pentane-1,5-diol, n-hexane-1,6-diol, 2-ethylhexane-1,6-diol, 2,3-dimethylhexane-1,6-diol, heptane-1,7-diol, cyclohexane-1,4-diol, nonane-1,7-diol, nonane-1,9-diol, 3,6-dimethyl-nonane-1,9-diol, decane-1,10-diol, dodecane-1,12-diol, 1,4-bis(hydroxymethyl)cyclohexane, 2-ethyl-1,4-bis(hydroxymethyl)-cyclohexane, 2-methyl-cyclohexane-1,4-diethanol, 2-methyl-cyclohexane-1,4-dipropanol, thio-dipropylene glycol, 3-methyl-pentane-1,5-dial, dibutylene glycol, 4,8-bis(hydroxymethyl)tricyclodecane, 2-butene-1,4-diol, p-xylylene glycol, 2,5-dimethyl-hexane-3-yne-2,5-diol, bis(2-hydroxyethyl)-sulfide, and 2,2,4,4-tetramethylcyclobutane-1,3-diol. In this embodiment, the content ratio (by mole) of the diol compound containing an ethylene glycol component or a propylene glycol component to the alcohol component in the acetal compounds or silyl ether compounds is preferably from 70:30 to 100:0, and more preferably from 85:15 to 100:0.

The acid decomposable compound in the invention has a weight average molecular weight of preferably 500 to 10000, and more preferably 1000 to 3000 in terms of standard polystyrene measured according to gel permeation chromatography (GPC).

As other acid decomposable compound, a compound having a Si—N bond disclosed in Japanese Patent O.P.I. Publication No. 62-222246, a carbonic acid ester disclosed in Japanese Patent O.P.I. Publication No. 62-251743, an orthotitanic acid ester disclosed in Japanese Patent O.P.I. Publication No. 62-280841, an orthosilicic acid ester disclosed in Japanese Patent O.P.I. Publication No. 62-280842, a compound having a C—S bond disclosed in Japanese Patent O.P.I. Publication No. 62-244038, or a compound having a —O—C(═O)— bond disclosed in Japanese Patent O.P.I. Publication No. 63-231442 can be used in combination.

Synthetic examples of the acid decomposable compound used in the invention will be described below.

### (Synthesis of Acid Decomposable Compound A-1)

A mixture of 1.0 mol of 1,1-dimethoxycyclohexane, 1.0 mol of ethylene glycol, 0.003 mol of p-toluene sulfonic acid hydrate and 500 ml of toluene was reacted at 100° C. for 1 hour with stirring, gradually elevated to 150° C. and reacted at 150° C. for additional 4 hours while methanol produced during reaction was removed. The reaction mixture solution was cooled, washed with water, an aqueous 1% sodium hydroxide solution, and an aqueous 1 N sodium hydroxide solution in that order. The resulting mixture was further washed with an aqueous saturated sodium chloride solution, and dried over anhydrous potassium carbonate. The solvent (toluene) of the resulting solution was removed by evaporation under reduced pressure to obtain a residue. The residue was further dried 80° C. for 10 hours under vacuum to obtain a wax compound. Thus, an acid decomposable compound A-1 in a waxy form was obtained. The weight average molecular weight Mw of compound A-1 was 1200 in terms of standard polystyrene measured according to GPC.

### (Synthesis of Acid Decomposable Compound A-2)

An acid decomposable compound A-2 in a waxy form was prepared in the same manner as in acid decomposable compound A-1, except that diethylene glycol was used instead of ethylene glycol. The weight average molecular weight Mw of compound A-2 was 2000.

### (Synthesis of Acid Decomposable Compound A-3)

An acid decomposable compound A-3 in a waxy form was prepared in the same manner as in acid decomposable compound A-1, except that triethylene glycol was used instead of ethylene glycol. The weight average molecular weight Mw of compound A-3 was 1500.

### (Synthesis of Acid Decomposable Compound A-4)

An acid decomposable compound A-4 in a waxy form was prepared in the same manner as in acid decomposable compound A-1, except that tetraethylene glycol was used instead of ethylene glycol. The weight average molecular weight Mw of compound A-4 was 1500.

### (Synthesis of Acid Decomposable Compound A-5)

An acid decomposable compound A-5 in a waxy form was prepared in the same manner as in acid decomposable compound A-1/except that dipropylene glycol was used instead of ethylene glycol. The weight average molecular weight Mw of compound A-5 was 2000.

### (Synthesis of Acid Decomposable Compound A-6)

An acid decomposable compound A-6 in a waxy form was prepared in the same manner as in acid decomposable compound A-2, except that benzaldehyde dimethylacetal was used instead of 1,1-dimethoxycyclohexane. The weight average molecular weight Mw of compound A-6 was 2000.

### (Synthesis of Acid Decomposable Compound A-7)

An acid decomposable compound A-7 in a waxy form was prepared in the same manner as in acid decomposable compound A-2, except that furaldehyde dimethylacetal was used instead of 1,1-dimethoxycyclohexane. The weight average molecular weight Mw of compound A-7 was 2000.

### (Synthesis of Acid Decomposable Compound S)

Two hundred milliliters of a dichlorodimethylsilane toluene solution in which 1.0 mol of dichlorodimethylsilane was dissolved were dropwise added to a mixture solution of 1.0 mol of diethylene glycol, 2.2 mol of pyridine and 800 ml of dry distilled toluene which was distilled after drying, while cooled with ice. The resulting solution was reacted at 50° C. for 8 hours with stirring, and filtered off to remove pyridine hydrochloride precipitates. The solvent (toluene) of the thus obtained filtrate was removed by evaporation under reduced pressure to obtain a residue. The residue was further dried 80° C. for 10 hours under vacuum to obtain an Acid Decomposable Compound S. The weight average molecular weight Mw of Acid Decomposable Compound S was 2000.

The content of the acid decomposable compound in the lower layer is preferably from 0.5 to 50% by weight, and more preferably from 1 to 30% by weight, in view of sensitivity, development latitude, and safelight property.

The acid decomposable compound in the invention may be used singly or as an admixture of two or more kinds thereof.

The acid decomposable compound in the invention may be contained in the upper layer.

### (Acid Generating Agent)

The lower layer in the invention preferably contains an acid generating agent. The acid generating agent is a compound generating an acid on light exposure or heat application. As the acid generating agents, there are various conventional compounds and mixtures. For example, a salt of diazonium, phosphonium, sulfonium or iodonium ion with BF₄⁻, PF₆⁻, SbF₆⁻ SiF₆²⁻ or ClO₄⁻, an organic halogen containing compound, o-quinonediazide sulfonylchloride or a mixture of an organic metal and an organic halogen-containing compound can be used as the acid generating agent in the invention.

An organic halogen-containing compound capable of generating a free radical, which is well known as a photoinitiator, is a compound capable of generating a hydrogen chloride, and can be also used as the acid generating agent. Further, there are compounds represented by iminosulfonates disclosed in Japanese Patent O.P.I. Publication No. 4-365048, which are photolytically decomposed to generate an acid, disulfone compounds disclosed in Japanese Patent O.P.I. Publication No. 61-166544, o-naphthoquinonediazide-4-sulfonic acid halides disclosed in Japanese Patent O.P.I. Publication No. 50-36209 (U.S. Pat. No. 3,969,118), and o-naphthoquinonediazides disclosed in Japanese Patent O.P.I. Publication No. 55-62444 (British patent No. 2038801) and Japanese Patent Publication No. 1-11935. As other examples of acid generating agent there are cyclohexyl citrate, sulfonic acid alkyl esters such as cyclohexyl p-benzene sulfonate and cyclohexyl p-acetoaminobenzene sulfonate, and alkyl sulfonates.

Examples of the organic halogen-containing compound capable of forming a hydrogen halide include those disclosed in U.S. Pat. Nos. 3,515,552, 3,536,489 and 3,779,778 and West German Patent No. 2,243,621, and compounds generating an acid by photodegradation disclosed in West German Patent No. 2,610,842. AS the photolytically acid generating agent, o-naphthoquinone diazide-4-sulfonylhalogenides disclosed in Japanese Patent O.P.I. Publication No. 50-36209 can be also used.

The acid generating agent is preferably an organic halogen-containing compound in view of sensitivity to infrared rays and storage stability of an image forming material using it. The organic halogen-containing compound is preferably a halogenated alkyl-containing triazines or a halogenated alkyl-containing oxadiazoles. Of these, halogenated alkyl-containing s-triazines are especially preferable. Examples of the halogenated alkyl-containing oxadiazoles include 2-halomethyl-1,3,4-oxadiazole compounds disclosed in Japanese Patent O.P.I. Publication Nos. 54-74728, 55-24113, 55-77742, 60-3626 and 60-138539.

Among compounds generating an acid on radiation exposure or heat application, those especially effectively used will be listed below.

As those effectively used, there are mentioned oxazole derivatives represented by formula (PAG1) or s-triazine derivatives represented by formula (PAG2) each having a trihalomethyl group, Iodonium salts represented by formula (PAG3), sulfonium salts represented by formula (PAG4), diazonium salts, disulfone derivatives represented by formula (PAG5) or iminosulfonate derivatives represented by formula (PAG6).

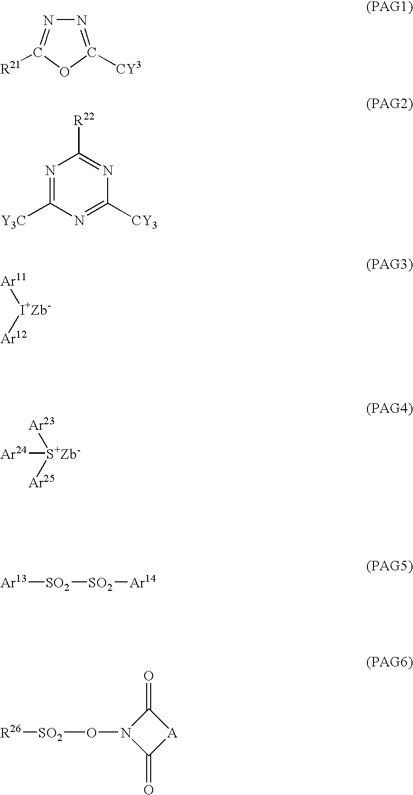

In formulae (PAG1) and (PAG2) above, R²¹ represents a substituted or unsubstituted aryl group or a substituted or unsubstituted alkenyl group; R²² represents a substituted or unsubstituted aryl group, a substituted or unsubstituted alkenyl group, a substituted or unsubstituted alkyl group, or —C(Y₁)₃ in which Y₁ represents a chlorine atom or a bromine atom; and Y represents a chlorine atom or a bromine atom. In formulae (PAG3) and (PAG4) above, Ar¹¹ and Ar¹² independently a substituted or unsubstituted aryl group; Ar²³, Ar²⁴ and Ar²⁵ independently a substituted or unsubstituted alkyl group or a substituted or unsubstituted aryl group, provided that Ar¹¹ and Ar¹², or two of Ar²³, Ar²⁴ and Ar²⁵ may combine with each other through a chemical bond or a divalent linkage group; and Zb⁻ represents an anion. In formulae (PAG5) and (PAG6) above, Ar¹³ and Ar¹⁴ independently a substituted or unsubstituted aryl group; R²⁶ represents a substituted or unsubstituted alkyl group or a substituted or unsubstituted aryl group; and A represents a substituted or unsubstituted alkylene, alkenylene or arylene group.

Examples thereof will be listed below, but the invention is not limited thereto.

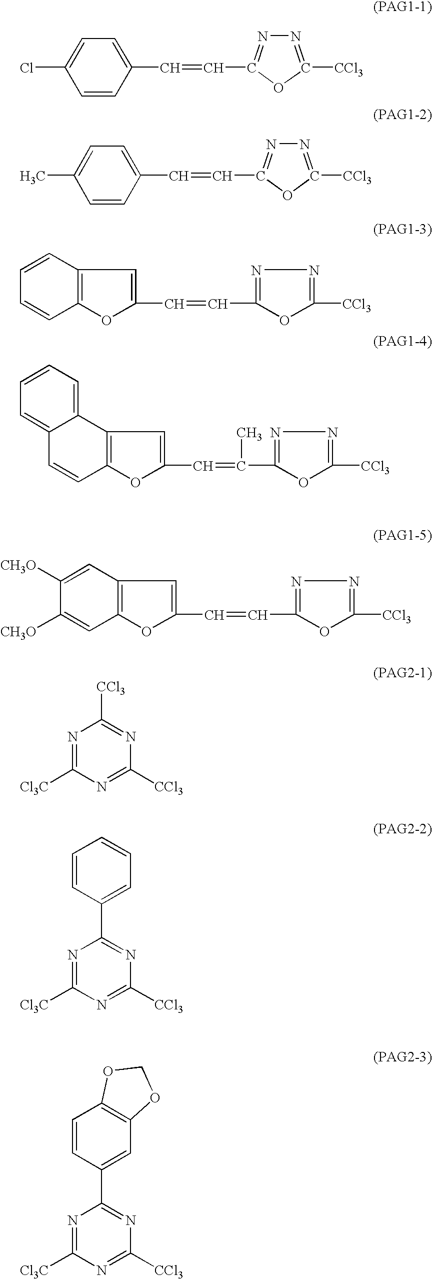

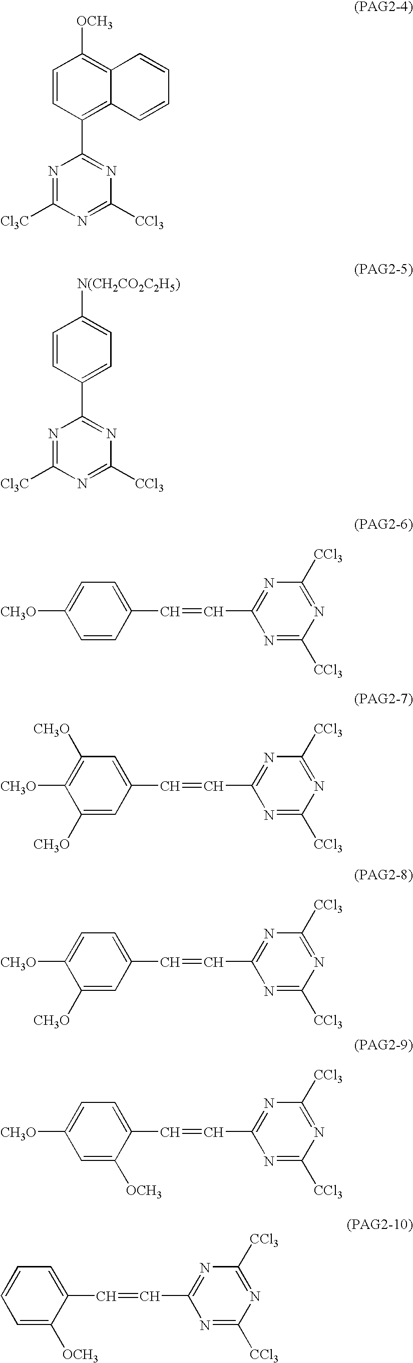

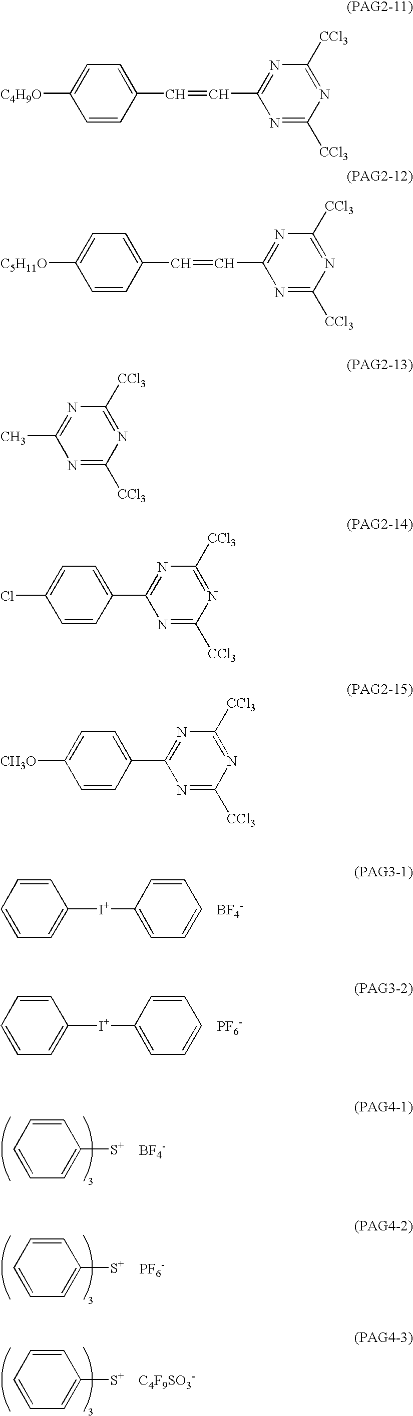

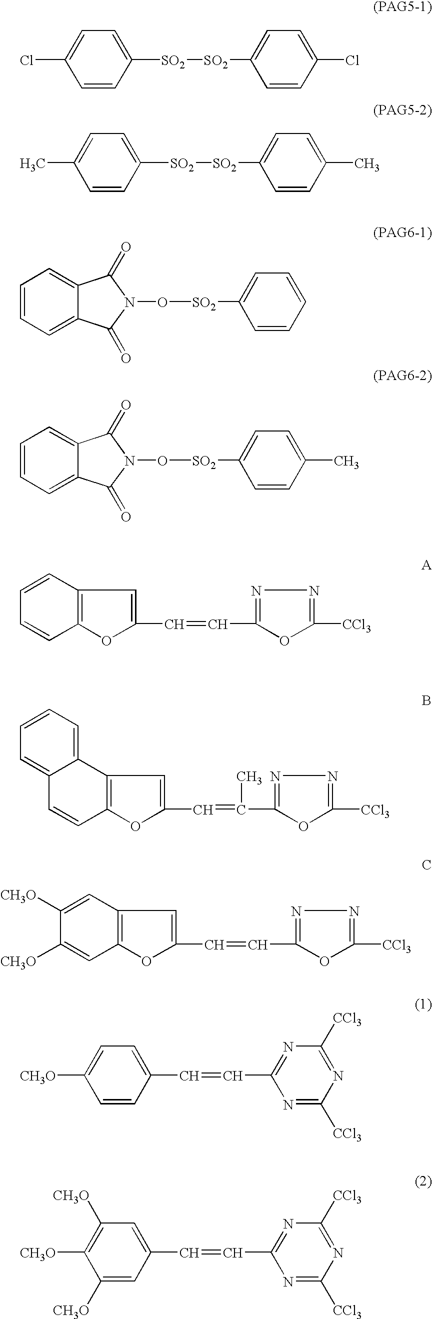

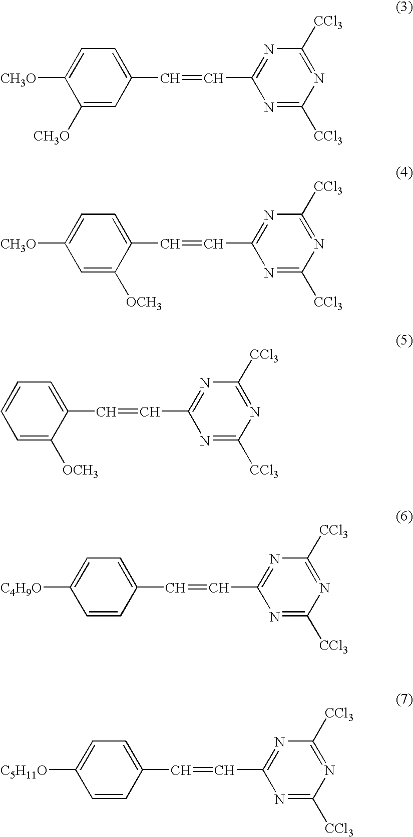

In the invention, acid generating agents described below can be employed.

For example, polymerization initiators disclosed in Japanese Patent O.P.I. Publication No. 2005-70211, radical generating compounds disclosed in Japanese Patent Publication No. 2002-537419, polymerization initiators disclosed in Japanese Patent O.P.I. Publication Nos. 2001-175006, 2002-278057, and 2003-5363, onium salts having two or more cation portions in the molecule disclosed in Japanese Patent O.P.I. Publication No. 2003-76010, N-nitroso amine compounds disclosed in Japanese Patent O.P.I. Publication No. 2001-133966, thermally radical generating compounds disclosed in Japanese Patent O.P.I. Publication No. 2001-343742, compounds of generating a radical or an acid by heat disclosed in Japanese Patent O.P.I. Publication No. 2002-6482, borate compounds disclosed in Japanese Patent O.P.I. Publication No. 2002-116539, compounds of generating a radical or an acid by heat disclosed in Japanese Patent O.P.I. Publication No. 2002-148790, photopolymerization initiators or thermal polymerization initiators each having a polymerizable unsaturated group disclosed in Japanese Patent O.P.I, Publication No. 2002-207293, onium salts having, as a counter ion, a divalent or more valent anion disclosed in Japanese Patent O.P.I, Publication No. 2002-268217, sulfonylsulfone compounds having a specific structure disclosed in Japanese Patent O.P.I. Publication No. 2002-328465, and thermally radical generating compounds disclosed in Japanese Patent O.P.I. Publication No. 2002-341519 can be used as necessary.

As the acid generating agents, compounds represented by the following formula (2) are also preferred, in view of safelight property.

R¹—C(X)₂—C═O)—R² Formula (2)

wherein R¹ represents a hydrogen atom, a bromine atom, a chlorine atom, an alkyl group, an aryl group, an acyl group, an alkylsulfonyl group, an arylsulfonyl group, an iminosulfonyl group or a cyano group; R² represents a hydrogen atom or a monovalent organic substituent, provided that R¹ and R² may combine with each other to form a ring; and X represents a bromine atom or a chlorine atom.

Among compounds represented by formula (2), those wherein R¹ is a hydrogen atom, a bromine atom, a chlorine atom are preferred in view of sensitivity. The monovalent organic substituent of R² is not limited, as long as the compounds represented by formula (2) generate a radical on light exposure. Those compounds in which in formula (2), R² represents —O—R³ or —NR⁴—R³ (R³ represents a hydrogen atom or a monovalent organic substituent, and R⁴ represents a hydrogen atom or an alkyl group) are preferably employed. Among these, those compounds in which R¹ is a bromine atom or a chlorine atom are more preferably employed in view of sensitivity.

Of these compounds, a compound having at least one haloacetyl group selected from a tribromoacetyl group, a dibromoacetyl group, a trichloroacetyl group, and a dichloroacetyl group is preferred.

In view of synthesis, a compound having at least one haloacetoxy group selected from a tribromoacetoxy group, a dibromoacetoxy group, a trichloroacetoxy group, and a dichloroacetoxy group, which is obtained by reacting a monohydric or polyhydric alcohol with a corresponding acid chloride, or a compound having at least one haloacetylamino group selected from a tribromoacetylamino group, a dibromoacetylamino group, a trichloroacetylamino group, and a dichloroacetylamino group, which is obtained by reacting a primary monoamine or primary polyamine with a corresponding acid chloride is especially preferred. Compounds having two or more of each of the haloacetyl group, haloacetoxy group, and haloacetylamino group are preferably used. These compounds can be easily synthesized by conventional esterification or amidation.

Typical synthesis method of the photopolymerization initiator represented by formula (2) is one in which alcohols, phenols or amines are esterified or amidated with acid chlorides such as tribromoacetic acid chloride, diibromoacetic acid chloride, trichlorooacetic acid chloride, or dichloroacetic acid chloride.

The alcohols, phenols or amines used above are arbitrary, and examples thereof include monohydric alcohols such as ethanol, 2-butanol, and 1-adamantanol; polyhydric alcohols such as diethylene glycol, trimethylol propane, and dipentaerythritol; phenols such as phenol, pyrogallol, and naphthol; monoamines such as morpholine, aniline, and 1-aminodecane; and polyamines such as 2,2-dimethylpropylene-diamine, and 1,12-dodecanediamine.

Preferred examples of the compounds represented by formula (2) will be listed below.

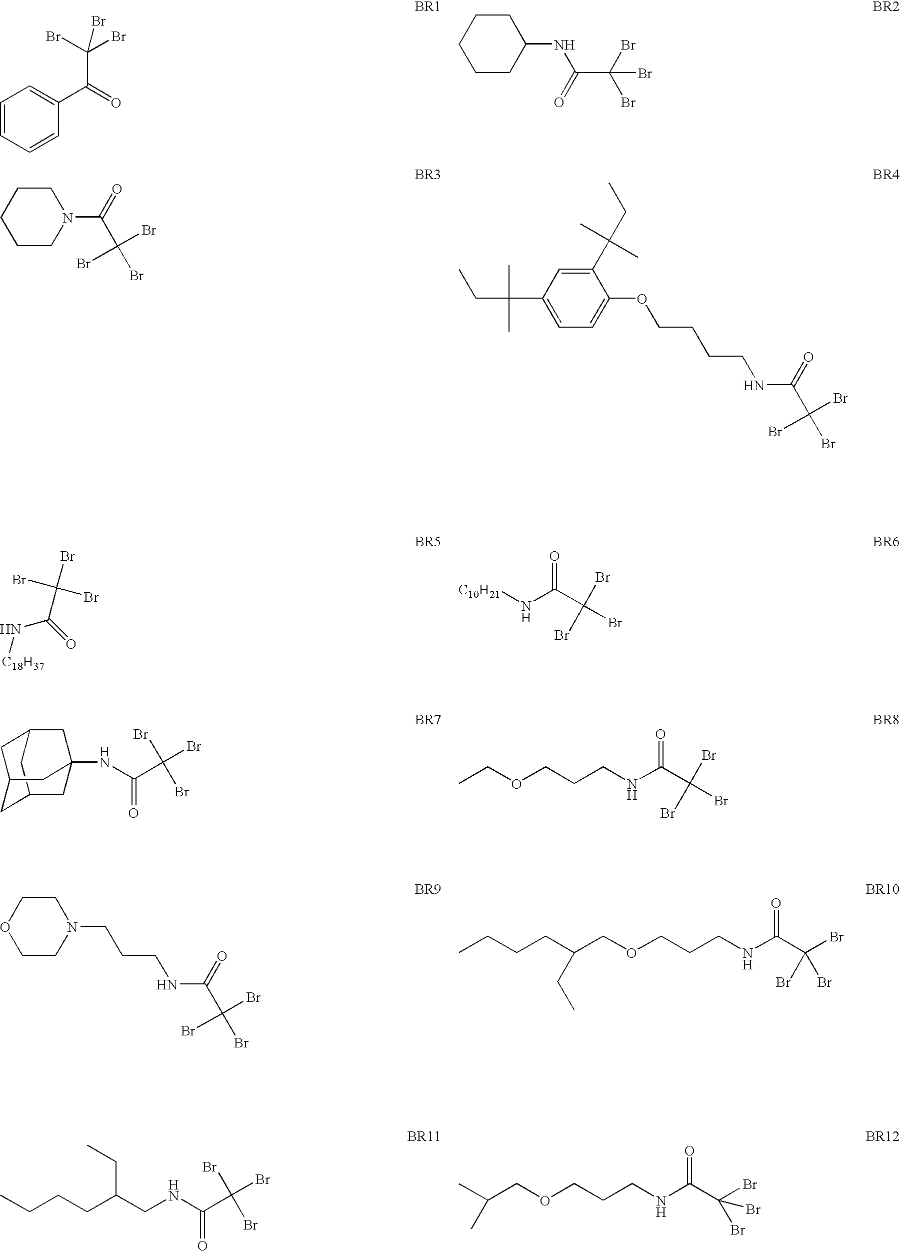

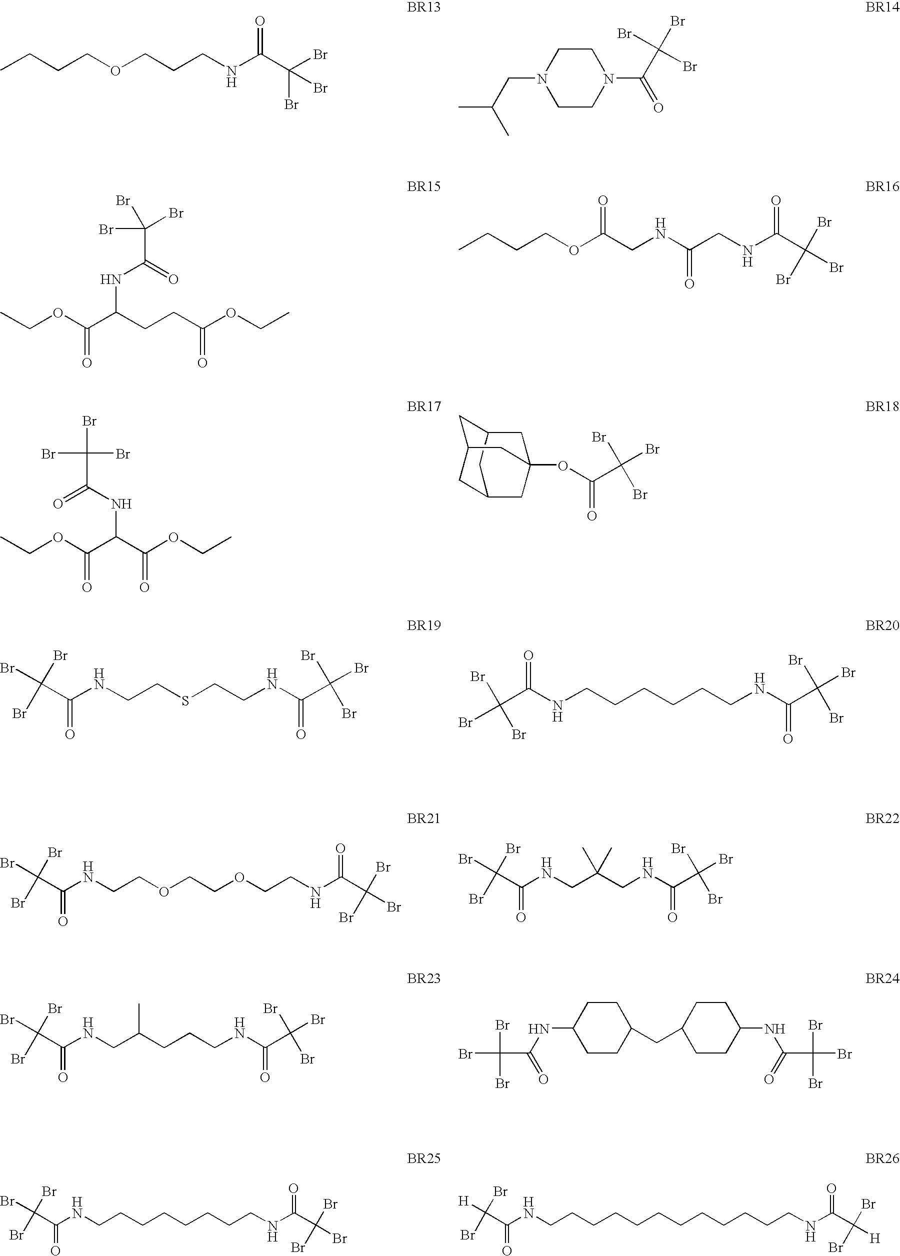

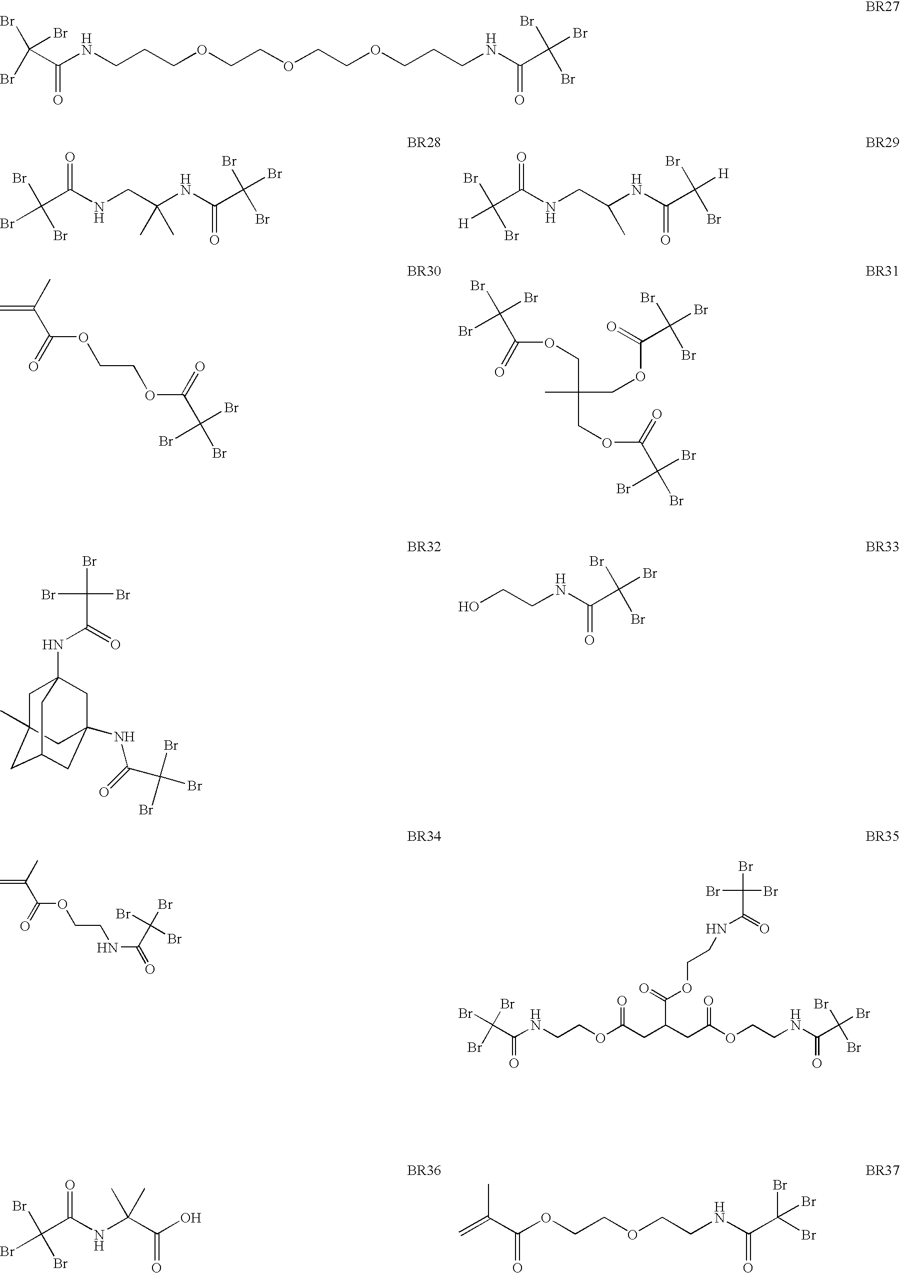

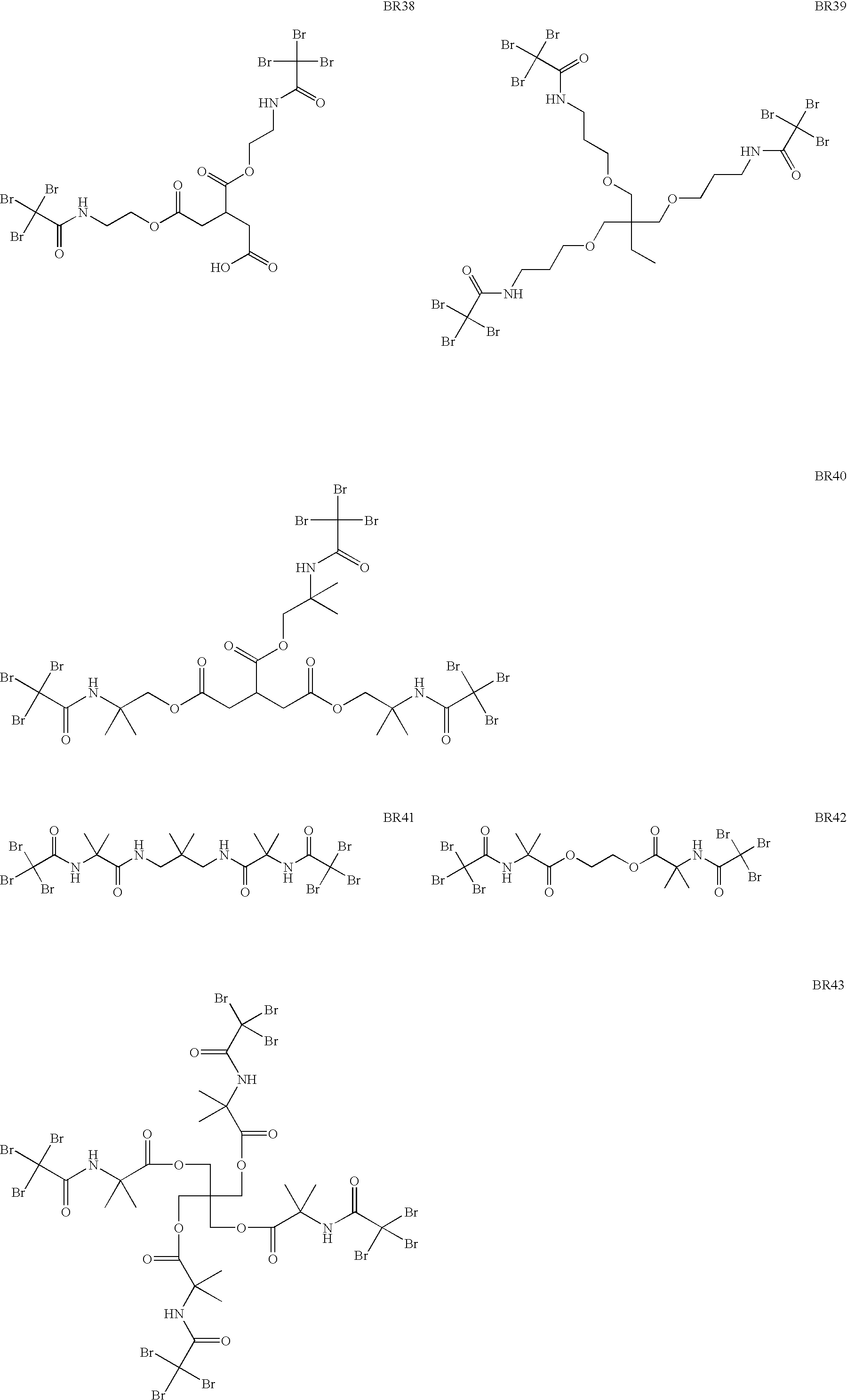

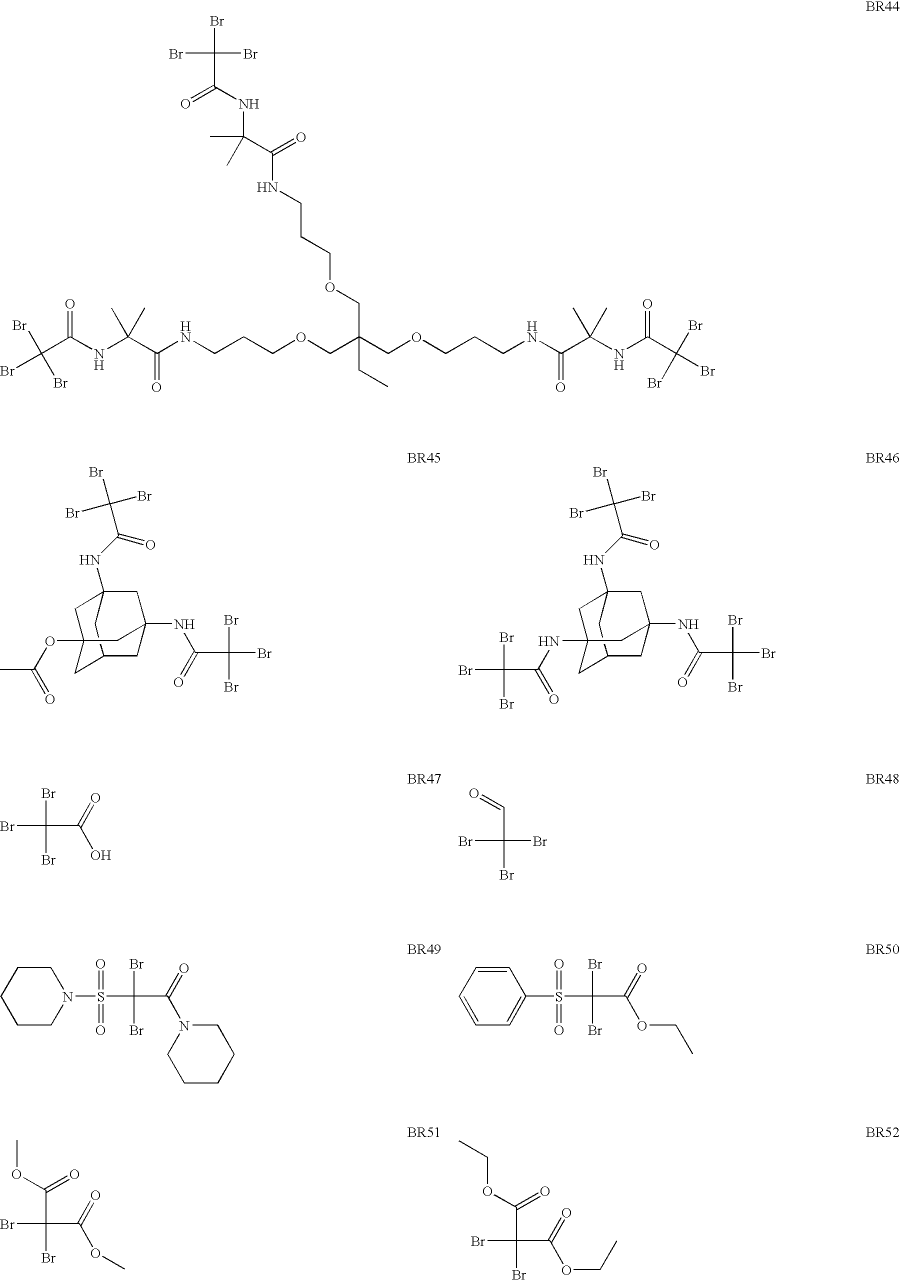

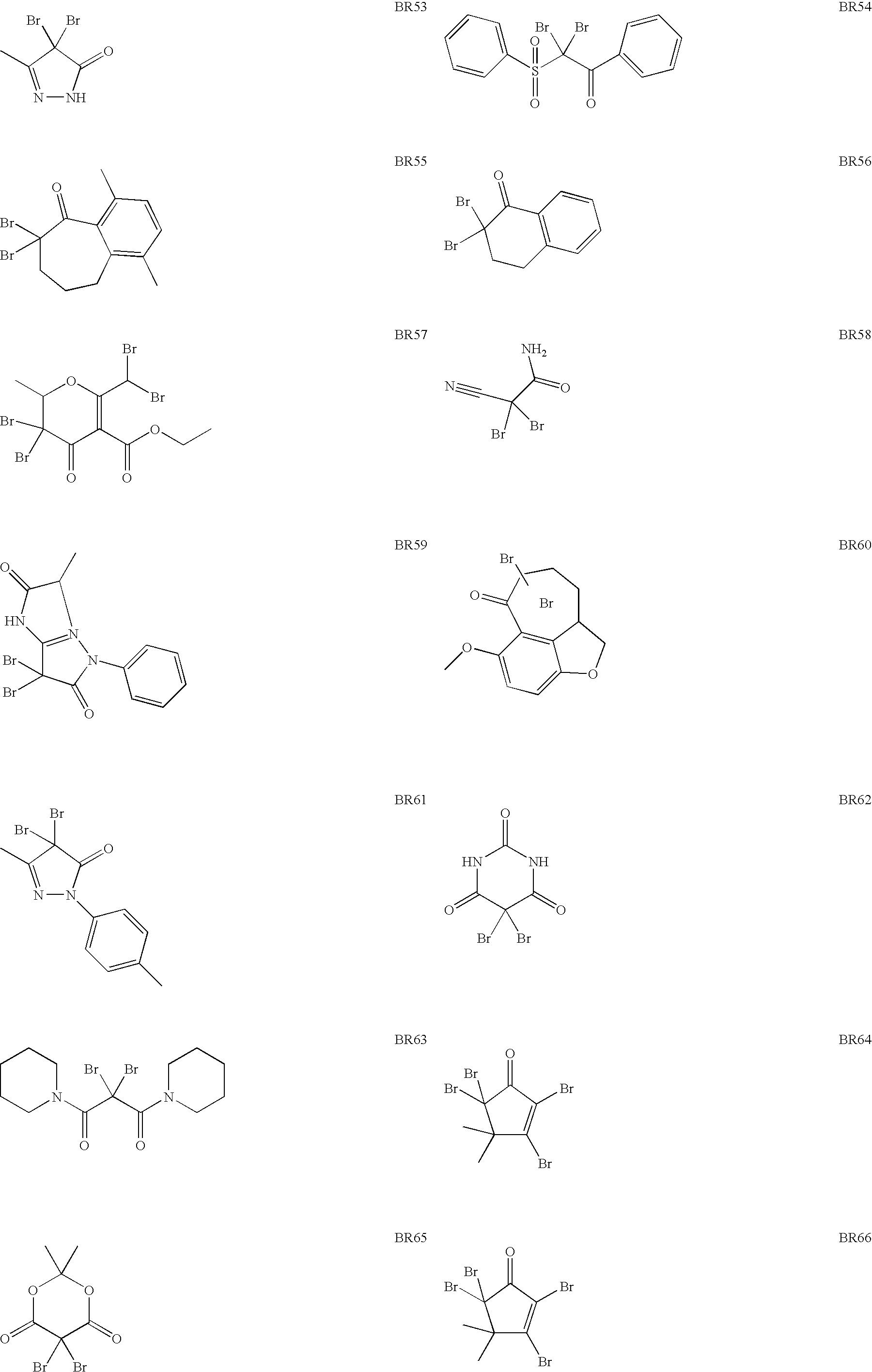

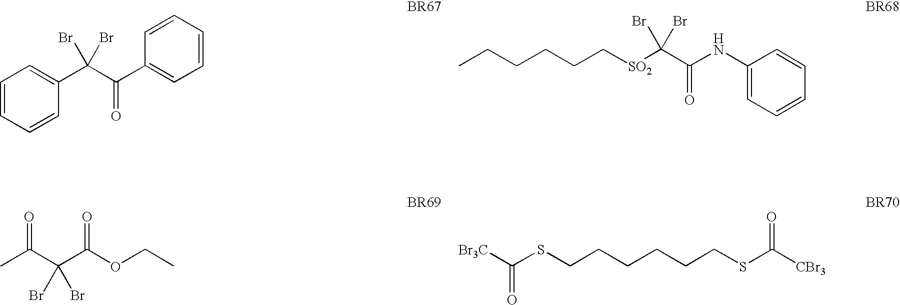

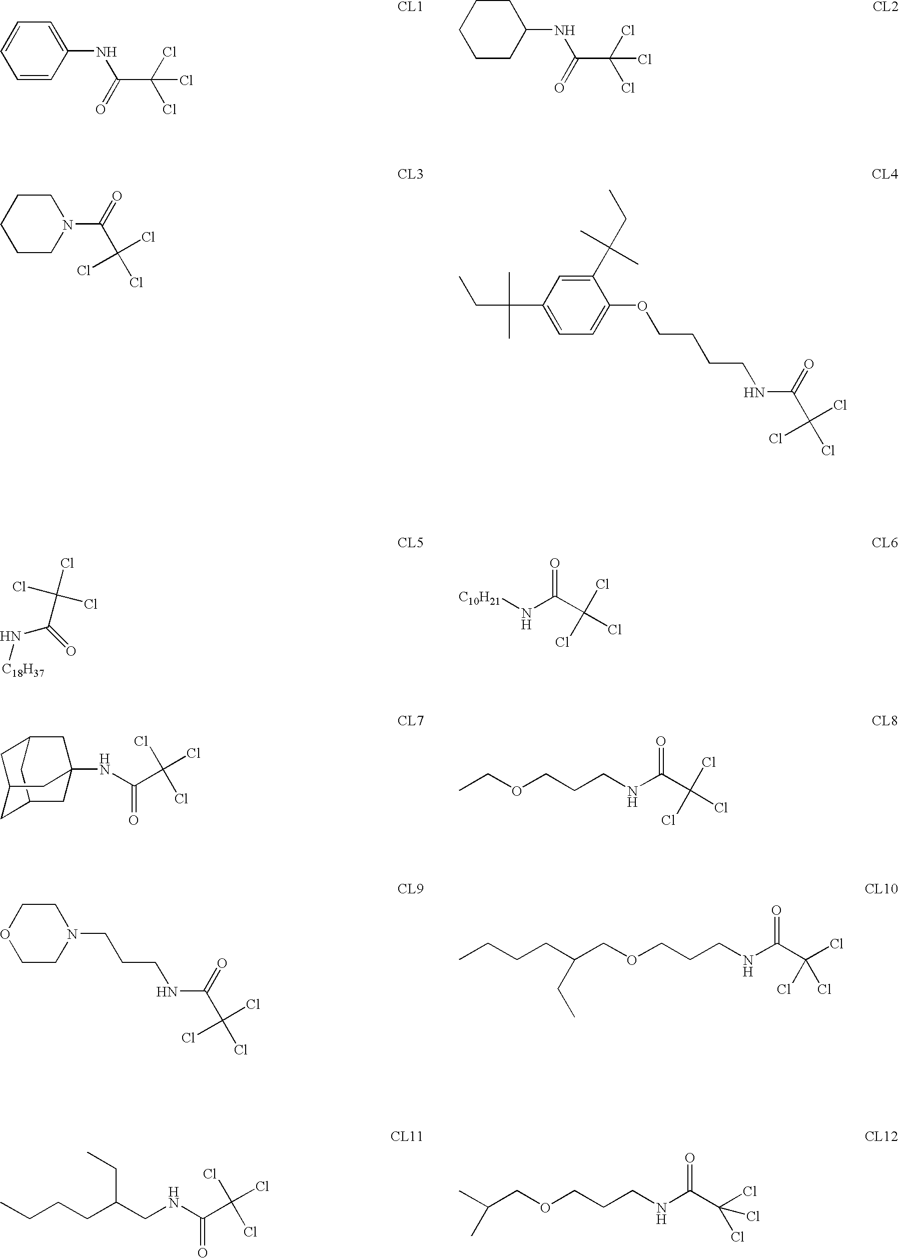

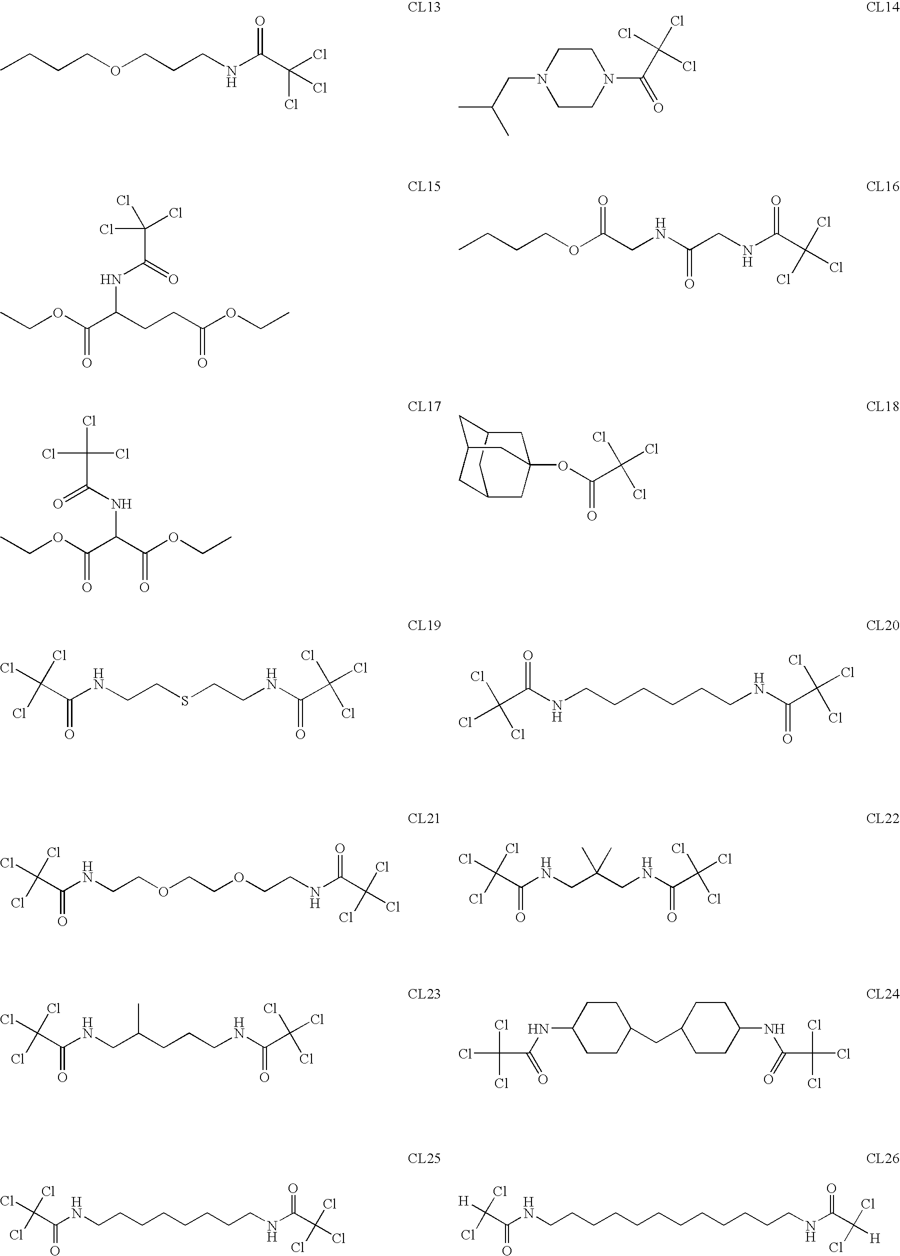

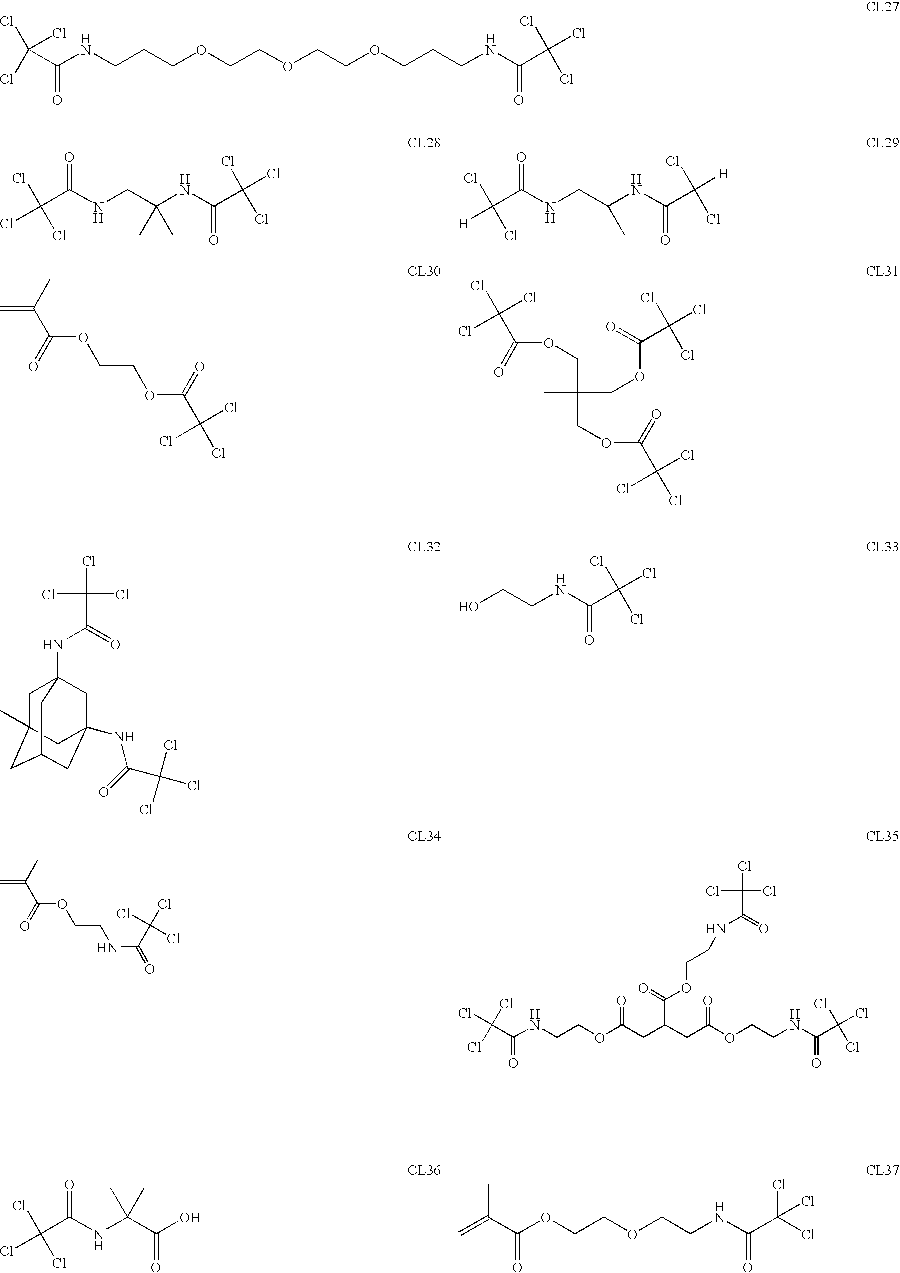

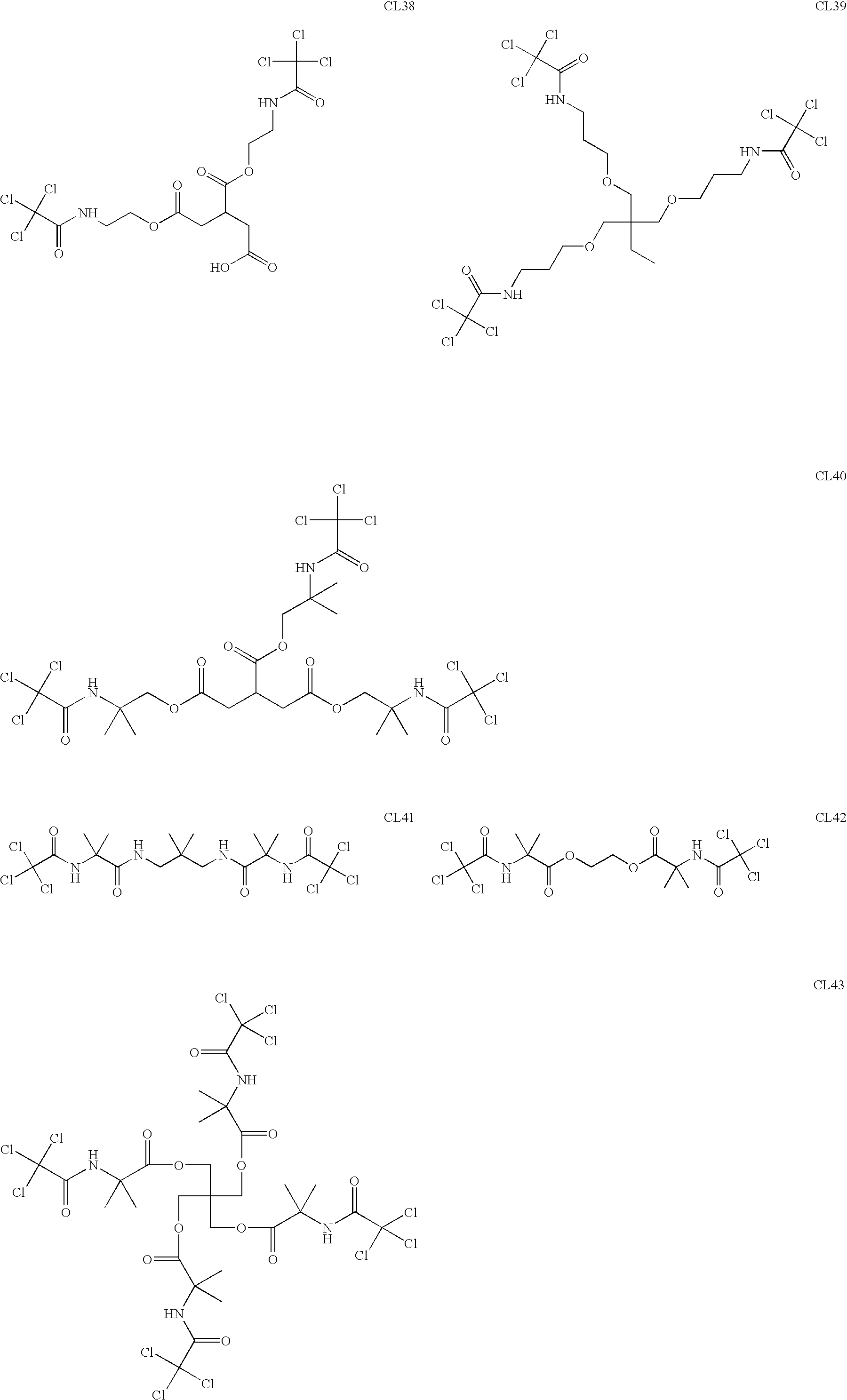

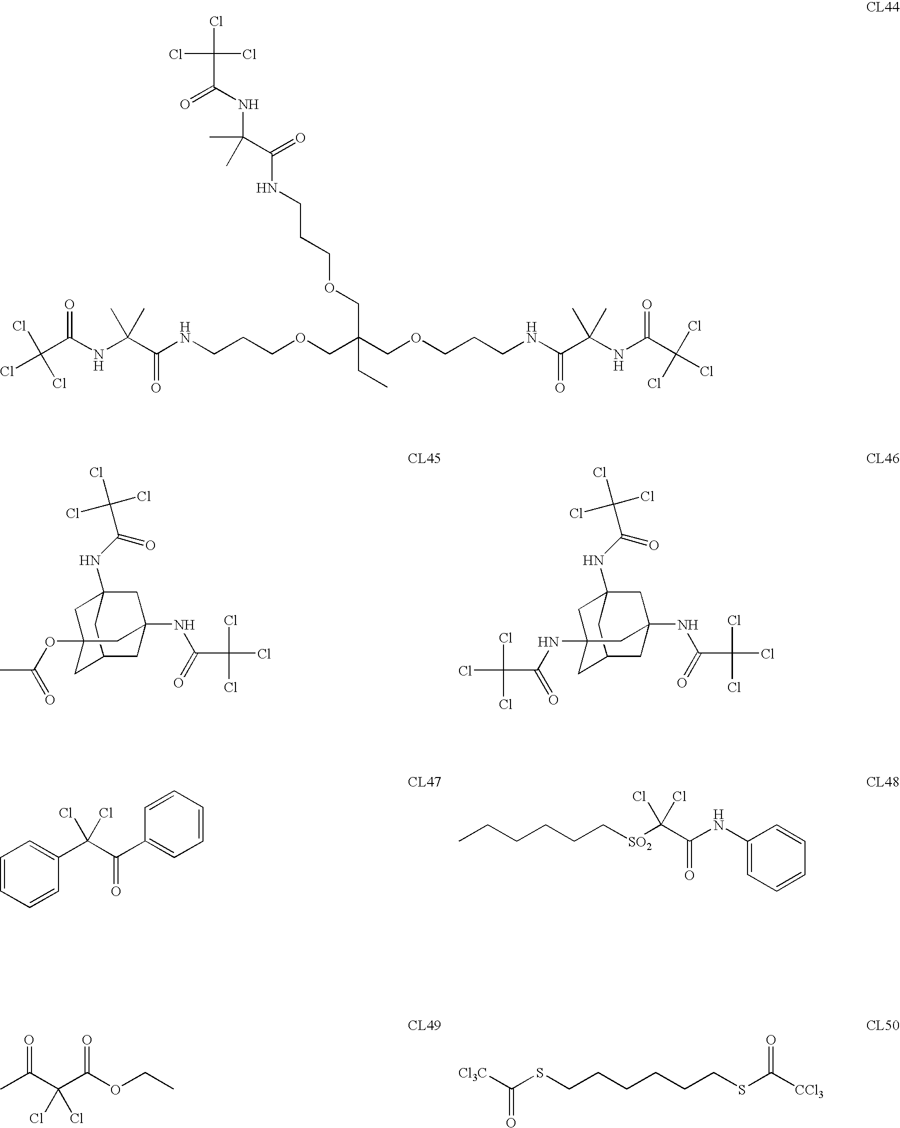

The acid generating agent content of the lower layer is ordinarily from 0.1 to 30% by weight, and preferably from 1 to 15% by weight, based on the total solid content of the lower layer, in view of development latitude and safelight property.

The acid generating agents may be used singly or as an admixture of two or more kinds thereof. The acid generating agents may be also incorporated into the upper layer as long as they do not lower safelight property.

### (Visualizing Agent)

The upper or lower layer in the invention preferably contains a colorant as a visualizing agent. As the visualizing agent, there are mentioned oil-soluble dyes and basic dyes.

Those changing the color by the action of a free radical or an acid are preferably used. The term “changing the color” means changing from colorless to color, from color to colorless, or from the color to different color. Preferred dyes are those changing the color by forming salts with an acid.

Examples of the dyes changing from color to colorless or from the color to different color include triphenyl methane, diphenyl methane, oxazine, xanthene, iminonaphthoquinone, azomethine or anthraquinone dyes represented by Victoria pure blue BOH (product of Hodogaya Kagaku), Oil blue #603 (product of Orient Kagaku kogyo), Patent pure blue (product of Sumitomo Mikuni Kagaku Co., Ltd.), Crystal violet, Brilliant green, Ethyl violet, Methyl violet, Methyl green, Erythrosine B, Basic fuchsine, Marachite green, Oil red, m-cresol purple, Rhodamine B, Auramine, 4-p-diethylaminophenyliminonaphthoquinone or cyano-p-diethylaminophenylacetoanilide.

Examples of the dyes changing from colorless to color include leuco dyes and primary or secondary amines represented by triphenylamine, diphenylamine, o-chloroaniline, 1,2,3-triphenylguanidine, diaminodiphenylmethane, p,p′-bis-dimethylaminodiphenylamine, 1,2-dianilinoethylene, p,p′,p″-tris-dimethylaminotriphenylmethane, p,p′-bis-dimethylaminodiphenylmethylimine, p,p′,p″-triamino-o-methyltriphenylmethane, p,p′-bis-dimethylaminodiphenyl-4-anilinonaphthylmethane, and p,p′,p″-triaminotriphenylmethane. These dyes may be used alone or as an admixture of two or more kinds thereof. Especially preferred dyes are Victoria pure blue BOH (product of Hodogaya Kagaku) and Oil blue #603.

The dye as the visualizing agent can be contained in the lower and/or upper layers, and is preferably contained in the lower layer. As the visualizing agent used in the upper layer, dyes having maximum absorption in the wavelength regions of less than 800 nm, and preferably less than 600 nm are preferably employed. When the acid generating agent is used in the lower layer, the above visualizing agent in the upper layer minimizes transmission of visible light, resulting in preferable results of improving safelight property. Such dyes are preferred since they can be used even when the acid generating agent unfavorable to safelight property is used in the lower layer.

The content of the dye is preferably 0.01 to 10% by weight, and more preferably from 0.1 to 3% by weight, based on the solid weight of layer containing the dyes.

### (Development Accelerator)

The upper or lower layer in the invention may comprise a compound with a low molecular weight having an acidic group as necessary in order to increase solubility.

The acidic groups include acidic groups providing a pKa of from 7 to 11 such as a thiol group, a phenolic hydroxyl group, a sulfonamido group and an active methylene group. The content of that compound is preferably from 0.05 to 5% by weight, and more preferably from 0.1 to 3% by weight, based on the weight of layer containing that compound.

### (Development Restrainer)

The upper or lower layer in the invention may contain various dissolution restrainers to adjust solubility. As the dissolution restrainers, there are disulfone compounds or sulfone compounds disclosed in Japanese Patent O.P.I. Publication No. 11-119418. As the development restrainers, 4,4′-bishydroxyphenylsulfone is preferably used. The content of the dissolution restrainers in the layer is preferably from 0.05 to 20% by weight, and more preferably from 0.5 to 10% by weights based on the weight of the layer.

In the invention, development restrainers can be used in order to increase dissolution restraint function. The development restrainers are not specifically limited as long as they are ones which are capable of lowering the solubility at exposed portions by their interaction with the alkali soluble resin described above and of being dissolved in a developer at exposed portions due to weak interaction with the alkali soluble resin. As the restrainers, quaternary ammonium salts or polyethylene glycol derivatives are preferably used.

Examples of the quaternary ammonium salts include tetraalkylammonium salts, trialkylarylammonium salts, dialkyldiarylammonium salts, alkyltriarylammonium salts, tetraarylammonium salts, cyclic ammonium salts and bicyclic ammonium salts, but are not specifically limited thereto. The content of the quaternary ammonium salts in the upper layer is preferably from 0.1 to 50% by weight, and more preferably from 1 to 30% by weight, based on the weight of the layer.

### (Sensitivity Improving Agent)

The upper or lower layer in the invention may contain cyclic acid anhydrides, phenols or organic acids to improve sensitivity.

As the cyclic acid anhydrides, there are phthalic anhydride, tetrahydrophthalic anhydride, hexahydrophthalic anhydride, 3,6-endoxy-Δ4 tetrahydrophthalic anhydride, tetrachlorophthalic anhydride, maleic anhydride, chloromaleic anhydride, α-phenylmaleic anhydride, succinic anhydride, pyromellitic anhydride disclosed in U.S. Pat. No. 4,115,128.

As the phenols, there are bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, and 4,4′,3″,4″-tetrahydroxy-3,5,3′,5′-tetramethylphenylmethane.

As the organic acids, there are sulfonic acids, sulfinic acids, alkyl sulfates, phosphonic acids, phosphates and carboxylic acids disclosed in Japanese Patent O.P.I. Publication Nos. 60-88942 and 2-96744. Examples thereof include p-toluene sulfonic acid, dodecylbenzene sulfonic acid, naphthalene sulfonic acid, p-toluene sulfinic acid, ethyl sulfuric acid, phenyl phosphonic acid, phenyl phosphinic acid, phenyl phosphate, diphenyl phosphate, benzoic acid, isophthalic acid, adipic acid, p-toluic acid, 3,4-dimethoxybenzoic acid, phthalic acid, telephthalic acid, 4-cyclohexene-1,2-dicarboxylic acid, erucic acid, lauric acid, n-undecylic acid, and ascorbic acid.

The content of the cyclic acid anhydrides, phenols or organic acids is preferably from 0.05 to 20% by weight, more preferably from 0.1 to 15% by weight, and still more preferably from 0.1 to 10% by weight, based on the weight of the layer containing them.

Alcohols having in the α-position at least one trifluoromethyl group disclosed in Japanese Patent O.P.I. Publication No. 2005-99298 can be used. This compound increases alkali solubility since acidity of the hydroxy group in the α-position is increased due to electron drawing effect of the trifluoromethyl group.

### (Back Coat Layer)

The aluminum support of the planographic printing plate material of the invention is preferably an aluminum support having an anodization film on both surfaces. A back coat layer may be provided on a rear surface of the aluminum support (the surface of the aluminum support opposite the upper layer as described above) in order to minimize dissolution of the anodization film on alkali development of the planographic printing plate material. The back coat layer is preferred, since it minimizes sludge produced during development, shorten developer exchange period, and lessens supply amount of developer replenisher. The back coat layer preferably contains (a) metal oxides obtained from hydrolysis or polycondensation of organic or inorganic metal compounds, (b) colloidal silica sol and (c) an organic polymeric compound.

Examples of the metal oxides used in the back coat layer include silica (silicon oxide), titanium oxide, boron oxide, aluminum oxide, zirconium oxide, and their composites. The metal oxides used in the back coat layer is formed by coating a sol-gel reaction solution on the rear surface of the aluminum support and drying it, the sol-gel reaction solution being obtained by hydrolyzing and condensing organic or inorganic metal compounds in water and an organic solvent in the presence of a catalyst such as an acid or an alkali. As the organic or inorganic metal compounds used herein, there are metal alkoxide, metal acetylacetonate, metal acetate, metal oxalate, metal nitrate, metal sulfate, metal carbonate, metal oxychloride, metal chloride, and their oligomers obtained by partially hydrolyzing and condensing these metal compounds.

### (Coating and Drying)

The lower layer and upper layer of the planographic printing plate material of the invention are ordinarily formed by dissolving the components described above in an appropriate coating solvent to obtain a respective coating solution and coating the coating solution on an appropriate support in order. Coating solvents will be shown below. These solvents may be used singly or as an admixture of two or more kinds thereof.

### (Coating Solvents)

As the coating solvents, there are, for example, n-propanol, isopropyl alcohol, n-butanol, sec-butanol, isobutanol, 2-methyl-1-butanol, 3-methyl-1-butanol, 2-methyl-2-butanol, 2-ethyl-1-butanol, 1-pentanol, 2-pentanol, 3-pentanol, n-hexanol, 2-hexanol, cyclohexanol, methylcyclohexanol, 1-heptanol, 2-heptanol, 3-heptanol, 1-octanol, 4-methyl-2-pentanol, 2-hexylalcohol, benzyl alcohol, ethylene glycol, diethylene glycol, triethylene glycol, tetraethylene glycol, 1,3-propane diol, 1,5-pentane glycol, dimethyl triglycol, furfuryl alcohol, hexylene glycol, hexyl ether, 3-methoxy-1-methylbutanol, butyl phenyl ether, ethylene glycol monoacetate, propylene glycol monomethylether, propylene glycol monoethylether, propylene glycol monopropylether, propylene glycol monobutylether, propylene glycol phenylether, dipropylene glycol monomethylether, dipropylene glycol monoethylether, dipropylene glycol monopropylether, dipropylene glycol monombutylether, tripropylene glycol monomethylether, methyl carbitol, ethyl carbitol, ethyl carbitol acetate, butyl carbitol, triethylene glycol monomethylether, triethylene glycol monoethylether, tetraethylene glycol dimethylether, diacetone alcohol, acetophenone, cyclohexanone, methyl cyclohexanone, acetonylacetone, isophorone, methyl lactate, ethyl lactate, butyl lactate, propylene carbonate, phenyl acetate, sec-butyl acetate, cyclohexyl acetate, diethyl oxalate, methyl benzoate, ethyl benzoate, γ-butyrolactone, 3-methoxy-1-butanol, 4-methoxy-1-butanol, 3-ethoxy-1-butanol, 3-methoxy-3-methyl-1-butanol, 3-methoxy-3-ethyl-1-pentanol, 4-ethoxy-1-pentanol, 5-methoxy-1-hexanol, 3-hydroxy-2-butanone, 4-hydroxy-2-butanone, 4-hydroxy-2-pentanone, 5-hydroxy-2-pentanone, 4-hydroxy-3-pentanone, 6-hydroxy-2-pentanone, 6-hydroxy-2-hexanone, 3-methyl-3-hydroxy-2-pentanone, methyl cellosolve (MC), and ethyl cellosolve (EC).

Regarding a coating solvent for the upper or lower layer, the coating solvent for the upper layer is preferably different in solvency to an alkali soluble resin from that for the lower layer. When an upper layer coating solution is coated on a lower layer surface, employing, as a coating solvent for the upper layer, a solvent dissolving the alkali soluble resin of the lower layer, the upper layer is mixed with the lower layer at the interface of the two layers, and the extreme cases of the mixing form a uniform single layer. Accordingly, such mixing is undesirable, since it may not show the effects of the invention that the two separate layers in the invention, i.e., the upper and lower layers provide. A solvent used in the upper thermosensitive layer coating solution is preferably a poor solvent of the alkali soluble resin contained in the lower layer.

In order to prevent mixing of the upper and lower layers, there are a method in which air is blown onto the coated surface with high pressure from slit nozzles arranged at right angle to the running direction of web, a method in which heat is supplied as conductive heat onto the rear surface through a heat roll inside which a heated medium such as vapor is supplied, and their combination, whereby a second coated layer coated on a first coated layer is rapidly dried.

As a method for mixing the two layers to the degree that the effects of the invention is produced, there is a method employing the solvency difference as described above of the coating solvents or a method rapidly drying the second coated layer coated on the first coated layer, both of which can adjust the degree.

The coating solution for the upper or lower layer has a total solid content (including additives) of preferably from 1 to 50% by weight. Although the dry coating amount of each layer, which has been formed on the support is different due to usage, the dry coating amount of the upper layer is preferably from 0.05 to 1.0 g/m², and the dry coating amount of the lower layer is preferably from 0.3 to 3.0 g/m². The above dry coating amount range of the upper layer is preferred in view of image formation properties and sensitivity. The total dry coating amount of the upper and lower layers is preferably from 0.5 to 3.0 g/m². The above total dry coating amount range is preferred in view of layer properties and sensitivity. When the dry coating amount is less, apparent sensitivity increases but layer properties deteriorate.

The coating solution prepared above is coated on a support according to a conventional method and dried to obtain a planographic printing plate material. As the coating methods, there are an air doctor coating method, a blade coating method, a wire bar coating method, a knife coating method, a dip coating method, a reverse roll coating method, a gravure coating method, a cast coating method, a curtain coating method, and an extrusion coating method. The drying temperature is preferably from 60 to 160° C., more preferably from 80 to 140° C., and still more from 90 to 120° C. An infrared radiation device can be used as a drying device to improve drying efficiency.

In the invention, a planographic printing plate material, which is obtained by coating the coating solution on a support and drying it, may be further subjected to aging treatment to stabilize the performance thereof. The aging treatment may be carried out in an aging device provided following a drying device or in an aging device provided separately. As disclosed in Japanese Patent O.P.I. Publication No. 2005-17599, the aging treatment may be used as a step in which OH groups on the layer surface are brought into contact with each other. In the aging treatment, a compound having a polar group represented by water permeates and diffuses from the layer surface to the inside of the layer whereby interaction in the layer is enhanced through water, cohesion is enhanced by heating, and performance of the layer is improved.

Temperature at the aging treatment is preferably set so that a specific amount of a compound to diffuse is evaporated. Typical examples of the compound to diffuse and permeate include water, and a compound having a polar group such as a hydroxyl group, a carboxyl group, a ketone group, an aldehydes group or an ester group. The boiling point of these compounds is preferably not more than 200° C., more preferably not more than 150° C., and preferably not less than 50° C., more preferably not less than 70° C. The molecular weight is preferably not more than 150, and more preferably not more than 100.

### (Surfactants)

In the invention, the upper and/or lower layer can contain non-ionic surfactants as disclosed in Japanese Patent O.P.I. Publication Nos. 62-251740 and 3-208514, amphoteric surfactants as disclosed in Japanese Patent O.P.I. Publication Nos. 59-121044 and 4-13149, siloxane compounds disclosed in EP 950517, or fluorine-containing copolymers disclosed in Japanese Patent O.P.I. Publication Nos. 62-170950, 11-288093, and 2003-57820, in order to improve the coatability and increase stability under various developing conditions.

Examples of the non-ionic surfactants include sorbitan tristearate, sorbitan monopalmitate, sorbitan trioleate, stearic acid monoglyceride, polyoxyethylene sorbitan monooleate, and polyoxyethylene nonylphenyl ether. Examples of the amphoteric surfactants include alkyldi(aminoethyl)-glycine, alkylpoly(aminoethyl)glycine hydrochloride, 2-alkyl-N-carboxyethyl-N-hydroxyethylimidazolinium betaine, and N-tetradecyl-N,N-betaine type compounds (for example, trade name: AMOGEN K produced by DAIICHI KOGYO CO., LTD.).

Examples of the siloxane compounds include a block copolymer of dimethyl polysiloxane and polyalkylene oxide, for example, polyalkylene oxide-modified silicons such as DBE-224, DBE-621, DBE-712, DBE-732, and DBE-534, each produced by Chisso Co., Ltd., and Tego Glide 100 produced by Tego Co., Ltd. The surfactant content of the upper or lower layer is preferably from 0.01 to 15% by weight, and more preferably from 0.1 to 5% by weight.

### <Exposure and Development>>

The above-obtained planographic printing plate material is ordinarily imagewise exposed and developed to prepare a planographic printing plate for printing.

A light source employed for imagewise exposure is preferably one having an emission wavelength in the wavelength regions of from near infrared to infrared, and more preferably a solid laser or a semiconductor laser. Imagewise exposure is carried out through an infrared laser (830 nm) based on digital converted data, employing a setter for CTP available on the market, followed by development, whereby a planographic printing plate with an image on the aluminum support used for printing is obtained.

An exposure device used in the invention is not specifically limited, as long as it is a laser method. Any of a method of laser scanning on an outer surface of a drum (an outer drum scanning method), a method of laser scanning on an inner surface of a drum (an inner drum scanning method), and a method of laser scanning on a plane (a flat head scanning method) can be used. The outer drum scanning method is preferably used which can easily provide multi-beams for improving productivity of low exposure intensity and long time exposure. An exposure device with a GLV modulation element employing the outer drum scanning method is especially preferred.

It is preferred in the invention that imagewise exposure is carried out employing an exposure device with a GLV modulation element whereby laser beams are multi-channeled, which improves productivity of planographic printing plates. The GLV modulation element is preferably one capable of dividing laser beams into not less than 200 channels, and more preferably one capable of dividing laser beams into not less than 500 channels. The laser beam spot diameter is preferably not more than 15 μm, and more preferably not more than 10 μm. The laser output power is preferably from 10 to 100 W, and more preferably from 20 to 80 W. The drum rotation number is preferably from 20 to 3000 rpm, and more preferably from 30 to 2000 rpm.

### (Developer)

A developer or developer replenisher applicable to the planographic printing plate material of the invention is one having a pH of from 9.0 to 14.0, and preferably from 12.0 to 13.5.

A developer including a developer replenisher (hereinafter also referred to as simply a developer) in the invention is a well known aqueous alkaline solution containing, as an alkali agent, sodium hydroxide, ammonium hydroxide, potassium hydroxide or lithium hydroxide. These alkali agents may be used singly or as an admixture of two or more kinds thereof. Other alkali agents include potassium silicate, sodium silicate, lithium silicate, ammonium silicate, potassium metasilicate, sodium metasilicate, lithium metasilicate, ammonium metasilicate, potassium phosphate, sodium phosphate, lithium phosphate, ammonium phosphate, potassium hydrogenphosphate, sodium hydrogenphosphate, lithium hydrogenphosphate, ammonium hydrogenphosphate, potassium carbonate, sodium carbonate, lithium carbonate, ammonium carbonate, potassium hydrogencarbonate, sodium hydrogencarbonate, lithium hydrogencarbonate, ammonium hydrogencarbonate, potassium borate, sodium borate, lithium borate and ammonium borate. Sodium hydroxide, ammonium hydroxide, potassium hydroxide or lithium hydroxide may be added to developer in order to adjust the pH of developer. An organic alkali agent such as monomethylamine, dimethylamine, trimethylamine, monoethylamine, diethylamine, triethylamine, monoisobutylamine, diisobutylamine, triisobutylamine, n-butylamine, monoethanolamine, diethanolamine, triethanolamine, monoisopropanolamine, diisopropanolamine, ethyleneimine, ethylenediamine or pyridine can be used in combination.

Among these, potassium silicate or sodium silicate is preferred. The concentration of silicate in the developer is preferably from 2 to 4% by weight in terms of SiO₂ concentration. The ratio by mole (SiO₂/M) of SiO₂ to alkali metal M is preferably from 0.25 to 2.

The developer in the invention refers to a developer (so-called working developer) replenished with developer replenisher in order to maintain activity of the developer which lowers during development of light sensitive planographic printing plate material, as well as fresh developer used at the beginning of development.

The developer or developer replenisher in the invention can contain various surfactants or organic solvents as necessary, in order to accelerate development, disperse smuts occurring during development, or enhance ink receptivity at the image portions of printing plate.

The developer or developer replenisher may contain the following additives in order to increase development performance. Examples of the additives include a neutral salt such as sodium chloride, potassium chloride, potassium bromide, as disclosed in Japanese Patent O.P.I. Publication No. 58-75152, a complex such as [Co(NH₃)₆]Cl₃ as disclosed in Japanese Patent O.P.I. Publication No. 59-121336, an amphoteric polymer such as a copolymer of vinylbenzyl-trimethylammonium chloride and sodium acrylate as disclosed in Japanese Patent O.P.I. Publication No. 56-142258, the organic metal containing surfactant containing Si or Ti as disclosed in Japanese Patent O.P.I. Publication No. 59-75255, and the organic boron containing compound disclosed in Japanese Patent O.P.I. Publication No. 59-84241.

The developer or developer replenisher in the invention can further contain an antiseptic agent, a coloring agent, a viscosity increasing agent, an antifoaming agent, or a water softener.

The developer or developer replenisher used in the invention is an aqueous concentrated solution with a low water content, which is diluted with water and used for development. The aqueous concentrated solution is advantageous in view of its transport. The degree of concentration of the concentrated solution is such that the components contained in the solution are not separated nor precipitated. The concentrated solution may contain a solubilizing agent. As the solubilizing agent is preferred so-called a hydrotrope such as toluene sulfonic acid, xylene sulfonic acid, or their alkali metal salt, which is disclosed in Japanese Patent O.P.I. Publication Nos. 6-32081.

### (Non-Silicate Developer)

Development of the planographic printing plate material of the invention can be also carried out employing a so-called “non-silicate developer” containing a non-reducing saccharide and a base but containing no alkali silicate. Development of the planographic printing plate material employing this developer provides a recording layer with good ink receptivity at the image portions without deteriorating the recording layer surface. Generally, development latitude of a planographic printing plate material is narrow, and the line width of line images of a developed planographic printing plate material is greatly changed due to pH of developer. Since the non-silicate developer contains a non-reducing saccharide with buttering property restraining a pH change, it is more advantageous than a developer containing a silicate. The non-silicate developer is also advantageous, since the non-reducing saccharide makes it difficult to contaminate an electrical conductivity sensor, a pH sensor, and the like controlling the activity of a developer, compared with a silicate Further, the non-silicate developer greatly improves discrimination between the image and non-image portions.

The non-reducing saccharide is one having neither aldehyde group nor ketone group and exhibiting no reducing power. The saccharide is classified into trehalose type oligosaccharide, in which the reducing groups are bonded to each other; glycoside, in which a reducing group of a saccharide is bonded to a non-saccharide; and saccharide alcohol obtained by reducing a saccharide by hydrogenation. In the invention, any one of these saccharides is preferably used. In the invention, non-reducing saccharides disclosed in Japanese Patent O.P.I. Publication No. 8-305039 can be suitably used.

These no-reducing saccharides may be used singly or as an admixture of two or more kinds thereof. The no-reducing saccharide content of the non-silicate developer is preferably from 0.1 to 30% by weight, and more preferably from 1 to 20% by weight, in view of availability and easiness of concentration.

### (Processing Method)

It is preferred that an automatic developing machine is used in order to prepare a planographic printing plate.

It is preferred that the automatic developing machine used in the invention is equipped with a means for automatically introducing a developer replenisher in a necessary amount into a developing bath, a means for discharging any excessive developer and a means for automatically introducing water in necessary amounts to the developing bath. It is preferred that the automatic developing machine comprises a means for detecting a planographic printing plate material to be transported, a means for calculating the area to be processed of the planographic printing plate material based on the detection, or a means for controlling a replenishing amount of a developer replenisher, a replenishing amount of water to be replenished or replenishing timing based on the detection and calculation. It is also preferred that the automatic developing machine comprises a means for controlling a temperature of a developer, a means for detecting a pH and/or electric conductivity of a developer, or a means for controlling a replenishing amount of the developer replenisher, a replenishing amount of water to be replenished and/or the replenishing timing based on the detected pH and/or electric conductivity.

The automatic developing machine may be provided with a pre-processing section to allow the plate to be immersed in a pre-processing solution prior to development. The pre-processing section is provided preferably with a mechanism of spraying a pre-processing solution onto the plate surface, preferably with a mechanism of controlling the pre-processing solution at a temperature within the range of 25 to 55° C., and preferably with a mechanism of rubbing the plate surface with a roller-type brush. Common water and the like are employed as the pre-processing solution.

The planographic printing plate material exposed and developed with the developer is preferably subjected to post-processing. The post-processing comprises the step of processing the developed planographic printing plate material with a post-processing solution such as washing water, a rinsing solution containing a surfactant, a finisher or a protective gumming solution containing gum arabic or starch derivatives as a main component. The post-processing is carried out employing an appropriate combination of the post-processing solutions described above. For example, a method is preferred in which the developed planographic printing plate material is post-washed with washing water, and then processed with a rinsing solution containing a surfactant, or a developed planographic printing plate precursor is post-washed with washing water, and then processed with a finisher, since it reduces fatigue of the rinsing solution or the finisher.

It is also preferred that a multi-step countercurrent processing is carried out employing a rinsing solution or a finisher. The post-processing is carried out employing an automatic developing machine having a development section and a post-processing section. In the post-processing step, the developed printing plate is sprayed with the post-processing solution from a spray nozzle or is immersed into the post-processing solution in a post-processing tank. A method is known in which supplies a small amount of water onto the developed printing plate precursor to wash the precursor, and reuses the water used for washing as dilution water for developer concentrate. In the automatic developing machine, a method is applied in which each processing solution is replenished with the respective processing replenisher according to the area of the printing plate precursor to have been processed or the operating time of the machine. A method (use-and-discard method) can be applied in which the developed printing plate material is processed with fresh processing solution and discarded. The thus obtained planographic printing plate is mounted on a printing press, and printing is carried out.

### (Burning Treatment)

The planographic printing plate obtained above is subjected to burning treatment in order to obtain a printing plate with high printing durability.

When the planographic printing plate is subjected to burning treatment, it is preferred that prior to the burning treatment, the printing plate is surface-processed with a cleaning solution disclosed in Japanese Patent Publication Nos. 612518 and 55-28062, and Japanese Patent O.P.I Publication Nos. 62-31859 and 61-159655.

As the surface-processing method, there is a method coating the cleaning solution on the planographic printing plate, employing a sponge or absorbent cotton impregnated with the cleaning solution, a method immersing the planographic printing plate in the vessel charged with the cleaning solution or a method coating the cleaning solution on the planographic printing plate employing an automatic coater. It is preferred that the coated cleaning solution is squeegeed with for example, a squeegee roller to give uniform coating.

The coating amount of the cleaning solution is ordinarily from 0.03 to 0.8 g/m², in terms of dry coating amount. If necessary, a planographic printing plate coated with the cleaning solution is dried and heated to high temperature, employing a burning processor (for example, a burning processor BP-1300, available from Fuji Photo Film Co., Ltd.). The heating temperature is preferably from 180 to 300° C., and the heating period is preferably from 1 to 20 minutes, although they are different due to kinds of components forming an image.

A planographic printing plate subjected to burning treatment can be subjected to conventional processing such as water washing or gumming, if necessary, but when the cleaning solution containing a water-soluble polymer is used, desensitizing treatment such as gumming can be eliminated. The thus obtained planographic printing plate is mounted on a printing press, followed by printing, whereby many prints are obtained.

### (Packaging Material and Interleaf)

An interleaf is preferably inserted between the two of the planographic printing plate materials of the invention, in order to prevent physical impact to the planographic printing plate material during storage or to minimize undesired impact during transportation. The interleaf is selected from many kinds thereof.

As an interleaf, one, which is manufactured employing inexpensive materials, is often used in order to reduce material cost. Examples thereof include a paper sheet comprised of 100% wood pulp, a paper sheet comprised of wood pulp and synthetic pulp, and a paper sheet in which a low or high density polyethylene film is provided on the paper sheet comprised of 100% wood pulp or the paper sheet comprised of wood pulp and synthetic pulp. A paper sheet, which does not employ synthetic pulp or polyethylene film can be manufactured at low cost, since the material cot is low.

A preferred interleaf is one having a basis weight of from 30 to 60 g/m², a smoothness of from 10 to 100 seconds, the smoothness measured according to a Bekk smoothness measuring method described in JIS 8119, a moisture content of from 4 to 8%, the moisture content measured according to a moisture content measuring method described in JIS 8127, and a density of from 0.7 to 0.9 g/cm³. An interleaf is preferably one in which a polymer film is not laminated on the surface facing the light sensitive layer, in order to absorb the residual solvents.

### (Printing)

Printing is carried out employing a conventional printing press.

In recent years, printing ink containing no petroleum volatile organic compound (VOC) has been developed and used in view of environmental concern. The present invention provides excellent effects in employing such a printing ink. Examples of such a printing ink include soybean oil ink “Naturalith 100” produced by Dainippon Ink Kagaku Kogyo Co., Ltd., VOC zero ink “TK HIGH ECO NV” produced by Toyo Ink Manufacturing Co., Ltd., and process ink “Soycelvo” produced by Tokyo Ink Co., Ltd.

### EXAMPLES

The present invention will be explained in detail below employing examples, but is not limited thereto. In the examples, “parts” is “parts by weight”, unless otherwise specified.

### (Preparation of Support)

### Preparation of Supports 1 and 2

A 0.24 mm thick aluminum plate (material 1050, refining H16) was immersed in an aqueous 5% by weight sodium hydroxide solution at 50° C. to give an aluminum dissolution amount of 2 g/m², washed with water, immersed in an aqueous 10% by weight nitric acid solution at 25° C. for 30 seconds to neutralize, and then washed with water.

Subsequently, the aluminum plate was subjected to electrolytic surface-roughening treatment in an electrolytic solution containing 10 g/liter of hydrochloric acid and 0.5 g/liter of aluminum at a current density of 60 A/dm² employing an alternating current with a sine waveform, in which the distance between the plate surface and the electrode was 10 mm. The electrolytic surface-roughening treatment was divided into 12 treatments, in which the quantity of electricity used in one treatment (at anodic time) was 80 C/dm², and the total quantity of electricity used (at anodic time) was 960 C/dm². Standby time of 1 second, during which no surface-roughening treatment was carried out, was provided after each of the separate electrolytic surface-roughening treatments.

Subsequently, the resulting aluminum plate was immersed in an aqueous 10% by weight phosphoric acid solution at 50° C. and etched to give an aluminum etching amount (including smut produced on the surface) of 1.2 g/m², and washed with water. Subsequently, the aluminum plate was subjected to anodizing treatment in an aqueous 20% by weight sulfuric acid solution at a quantity of electricity of 250 C/dm² under a constant voltage of 20V, and washed with water. The aluminum plate surface was squeegeed to remove the residual water on the surface, and the plate was immersed in an aqueous 2% by weight sodium silicate No. 3 solution at 85° C. for 30 seconds, washed with water, then immersed in an aqueous 0.4% by weight polyvinyl phosphonic acid (hereinafter referred to as PVPA) solution at 60° C. for 30 seconds, and washed with water. The aluminum plate surface being squeegeed, the aluminum plate was subjected to heating treatment at 130° C. for 50 seconds. Thus, a support was obtained.

The surface roughness R^{a} of the resulting support was 0.55 μm, measured through SE 1700a (available from Kosaka Kenkyusho Co., Ltd.). The support surface being observed through an SEM by a factor of 100000, the pore diameter of the anodization film was 40 nm. The polyvinyl phosphonic acid layer had a thickness of 0.01μ.

### (Preparation of Light Sensitive Planographic Printing Plate Material Samples)

The following lower layer coating solution was coated on the support, employing a three-roll coater and dried at 120° C. for 1 minute to give a lower layer with a dry coating amount of 0.85 g/m².

The following upper layer coating solution was coated on the resulting lower layer, employing a double-roll coater and dried at 120° C. for 1.5 minutes to give an upper layer with a dry coating amount of 0.25 g/m². The resulting coating material was cut into a size of 600×400 mm, and 200 sheets thereof were stacked, an interleaf P inserted between the two nearest sheets, and was subjected to aging treatment for 24 hours at 50° C. and at absolute humidity of 0.037 kg/kg. Thus, a light sensitive planographic printing plate material sample No. 6 was prepared. Light sensitive planographic printing plate material sample No. 1 was prepared in the same manner as light sensitive planographic printing plate material sample No. 6 above, except that neither the fluoroalkyl group-containing resin AP-1 in the lower layer nor the fluoroalkyl group-containing resin AP-1 in the upper layer was used. Light sensitive planographic printing plate material sample No. 2 was prepared in the same manner as light sensitive planographic printing plate material sample No. 6 above, except that neither of the acid decomposable compound and acid generating agent in the lower layer was used and the fluoroalkyl group-containing resin AP-1 in the upper layer was not used. Light sensitive planographic printing plate material sample No. 3 was prepared in the same manner as light sensitive planographic printing plate material sample No. 6 above, except that none of the acid decomposable compounds, acid generating agent and fluoroalkyl group-containing resin in the lower layer was used. Light sensitive planographic printing plate material sample No. 4 was prepared in the same manner as light sensitive planographic printing plate material sample No. 6 above, except that the fluoroalkyl group-containing resin AP-1 in the upper layer was not used. Light sensitive planographic printing plate material sample No. 5 was prepared in the same manner as light sensitive planographic printing plate material sample No. 6 above, except that the fluoroalkyl group-containing resin AP-1 in the lower layer was not used. Light sensitive planographic printing plate material sample No. 7 was prepared in the same manner as light sensitive planographic printing plate material sample No. 6 above, except that fluoroalkyl group-containing resin P-1 in an amount as shown in Table 1 was used in the lower layer instead of AP-1, and fluoroalkyl group-containing resin AP-1 was used in an amount as shown in Table 1. Light sensitive planographic printing plate material sample No. 8 was prepared in the same manner as light sensitive planographic printing plate material sample No-7 above, except that acid decomposable compound B was used instead of acid decomposable compounds A and B in the lower layer, and acid generating agent BR22 was used instead of acid generating agent TAZ-107. Light sensitive planographic printing plate material sample No. 9 was prepared in the same manner as light sensitive planographic printing plate material sample No. 8 above, except that acid decomposable compound S was used in the lower layer instead of acid decomposable compound B.

### (Interleaf P)

A rosin sizing agent was added to the paper stock solution having a 4% concentration of bleached kraft pulp to have a rosin sizing agent content of 0.4%, and aluminum sulfate was added thereto to give a pH of 5. Thereafter, a reinforcing agent comprised mainly of starch was added to give a reinforcing agent content of 5.0% by weight. Interleaf P with a basis weight of 40 g/m² and a moisture content of 0.5% was prepared from the resulting solution.

(Lower Layer Coating Solution)

| | | |
|---|---|---|
| Acryl resin 1 | 85.0 | parts |
| Victoria Pure Blue dye | 3.0 | parts |
| Acid decomposable compound A | 1.0 | part |
| Acid decomposable compound B | 4.0 | parts |
| Acid generating agent TAZ-107 | 1.5 | parts |
| (Triazine derivative produced by Midori Kagaku Co., Ltd.) | | |
| Infrared absorbing dye (Dye 1) | 5.0 | parts |
| Fluorine-containing surfactant | 0.8 | parts |
| Megafac F178K (produced by Dainippon Ink & Chemicals | | |
| Inc.) | | |
| Fluoroalkyl group-containing acryl resin AP-1 | 15 | parts |

The above components were dissolved in a solvent 7-butyrolactone/methyl ethyl ketone/1-methoxy-2-propanol (1/2/1) to make 1000 parts by weight of the lower layer coating solution.

(Upper Layer Coating Solution)

| | | |
|---|---|---|
| Cresol novolak resin | 34.0 | parts |
| (m/p = 7/3, molecular weight: 4000) | | |
| Acryl resin 1 | 4.0 | parts |
| Infrared absorbing dye (Dye 1) | 1.5 | parts |
| Fluorine-containing surfactant | 0.5 | parts |
| Megafac F178K (produced by Dainippon Ink & | | |
| Chemicals Inc.) | | |
| Fluoroalkyl group-containing acryl resin AP-1 | 20 | parts |

The above components were dissolved in a solvent γ-butyrolactone/methyl ethyl ketone/1-methoxy-2-propanol (1/2/1) to make 1000 parts by weight of the upper layer coating solution.

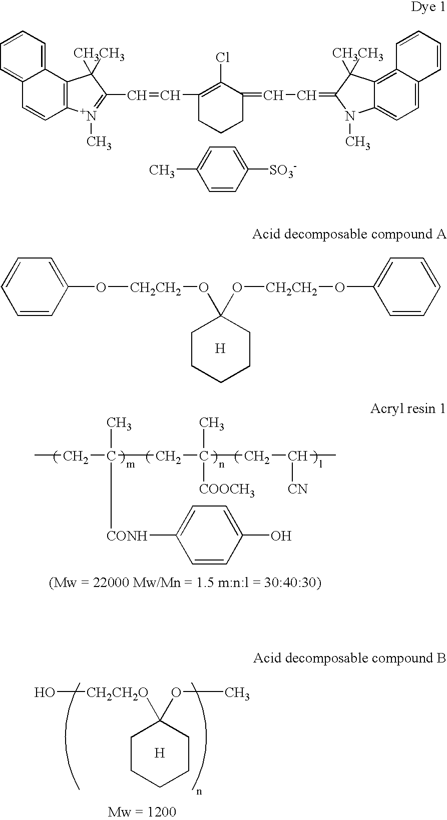

### (Exposure and Development)

Employing PTR-4300 (manufactured by Dainippon Screen Manufacturing Co., Ltd.), each of the resulting planographic printing plate material samples was imagewise exposed at a drum rotation number of 1000 rpm and at a resolution of 2400 dpi while the laser output power was changed from 30% to 100% to form a dot image with a screen line number of 175 lines. Herein, “dip” means a dot number per 2.54 cm.

Employing an automatic developing machine Raptor 85 Thermal (available from GLUNZ & JENSEN Cog, Ltd.), the exposed sample was developed with a developer PD1 (available from Kodak Polychrome Graphics Co., Ltd.) at 30° C. for 15 seconds. Thus, a planographic printing plate sample was obtained.

### <Evaluation>

### (Sensitivity)

The printing plate material sample was exposed while varying laser light exposure energy, and developed in the same manner as above to obtain solid image portions and non-image portions. The optical density of the resulting non-image portions was measured through a densitometer D196 (produced by GRETAG Co., Ltd.). The exposure energy providing an optical density of the support (uncoated) surface optical density plus 0.01 was determined and defined as sensitivity.

### (Chemical Resistance))

Each of the planographic printing plate material samples obtained above was imagewise exposed at energy which was 1.3 times higher than the energy providing sensitivity, and developed as above to obtain a printing plate sample was obtained. The resulting printing plate sample was mounted on a printing press LITHRONE (produced by Komori Corporation), and printing was carried out, where coated paper sheets, printing ink soybean oil ink Naturalith 100 (produced by Dainippon Ink Kagaku Kogyo Co., Ltd.), and dampening solution H solution SG-51 (concentration: 1.5%, produced by Tokyo Ink Co., Ltd.) were employed for printing Whenever 500 prints were obtained, printing was stopped, and the printing plate surface was cleaned with a plate cleaner Ultra Plate Cleaner (produced by available from Dainichi Seika Co., Ltd.), and then printing was restarted (one cycle). This process was repeated and the number of prints printed till when lack of small dots with a dot area of 3% on the resulting prints was observed was evaluated as a measure of chemical resistance.

### (Development Latitude)

Employing PTR-4300 (manufactured by Dainippon Screen Manufacturing Co., Ltd.), each of the resulting planographic printing plate material samples was imagewise exposed at a drum rotation number of 1000 rpm and at a resolution of 2400 dpi while the laser output power was changed from 30% to 100% to form a dot image with a screen line number of 175 lines.

Employing an automatic developing machine Raptor 85 Thermal (available from GLUNZ & JENSEN Co., Ltd.), the exposed sample was developed with a developer PD1 (available from Kodak Polychrome Graphics Co., Ltd.) at 30° C. for from 5 to 30 seconds. Thus, a planographic printing plate sample was obtained.

The developed sample was observed through a magnifier at a magnification of 50, and the developing time range during which neither contamination at non-image portions nor layer thickness reduction was determined and defined as developing latitude.

### (Image Uniformity)

The printing plate material sample was exposed through AM Screen to form a 50 to 90% screen image with a screen line number of 240 lines, and developed to obtain a planographic printing plate. The resulting planographic printing plate was mounted on a plate cylinder of a printing press LITHRON produced by Komori Corporation, and printing was carried out wherein coated paper sheets, printing ink (soybean ink “Naturalith 100” produced by Dainippon Ink Kagaku Co., Ltd.) and dampening water Solution H SG-51 (concentration 1.5%) produced by Tokyo Ink Co., Ltd. were used. Image uniformity of the resulting prints was evaluated according to the following criteria.

A: No image unevenness was observed.
B: Slight image unevenness was observed, but was practically non-problematic.
C: Image unevenness was observed, but was practically non-problematic.
D: Apparent image unevenness was observed, which was practically problematic.

The results are shown in Table 1.

TABLE 1

| | Lower Layer | | | Upper Layer | |
|---|---|---|---|---|---|
| | Acid | Acid | *F Acryl | F Acryl | |
| | Decom- | Gener- | Resin | Resin | |
| Sample | posable | ating | (parts by | (parts by | |
| No. | Compound | Agent | weight) | weight) | Remarks |
| 1 | A & B | TAZ-107 | None | None | Comp. |
| 2 | None | None | AP-1 (15) | None | Comp. |
| 3 | None | None | None | AP-1 (20) | Comp. |
| 4 | A & B | TAZ-107 | AP-1 (15) | None | Inv. |
| 5 | A & B | TAZ-107 | None | AP-1 (20) | Inv. |
| 6 | A & B | TAZ-107 | AP-1 (15) | AP-1 (20) | Inv. |
| 7 | A & B | TAZ-107 | P-1 (10) | AP-1 (15) | Inv. |
| 8 | B | BR 22 | P-1 (10) | AP-1 (15) | Inv. |
| 9 | S | BR 22 | P-1 (10) | AP-1 (15) | Inv. |

| | | Development | Chemical | | |
|---|---|---|---|---|---|
| Sample | Sensitivity | latitude | Resistance | Image | |
| No. | (mj/cm²) | (Seconds) | (Number) | Uniformity | Remarks |
| 1 | 140 | 50 | 50000 | D | Comp. |
| 2 | 220 | 25 | 70000 | D | Comp. |
| 3 | 260 | 15 | 100000 | D | Comp. |
| 4 | 120 | 60 | 150000 | C | Inv. |
| 5 | 100 | 50 | 200000 | B | Inv. |
| 6 | 100 | 60 | 250000 | A | Inv. |
| 7 | 90 | 70 | 250000 | A | Inv. |
| 8 | 70 | 80 | 300000 | A | Inv. |
| 9 | 90 | 60 | 250000 | A | Inv. |

Inv.: Inventive,
Comp.: Comparative
*F Acryl Resin: Fluoroalkyl group-containing acryl resin

As is apparent from Table 1, Inventive planographic printing plate material samples excel in sensitivity, development latitude and chemical resistance, as well as image uniformity.

What is claimed is:

1. A positive working light sensitive planographic printing plate material comprising an aluminum support and provided thereon, a lower image formation layer and an upper image formation layer in that order, wherein the upper image formation layer contains an alkali soluble resin, a light-to-heat conversion material and a fluoroalkyl group-containing acryl resin, and the lower image formation layer contains an alkali soluble resin and an acid decomposable compound represented by the following formula (1), 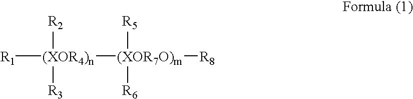
wherein n represents an integer of 1 or more; m represents an integer of 0 or more; X represents a carbon atom or a silicon atom; R₄ represents an ethyleneoxy group or a propyleneoxy group; R₂ and R₅ independently represent a hydrogen atom, an alkyl group or an aryl group; R₃ and R₆ independently represent an alkyl group or an aryl group, provided that R₂ and R₃ may combine with each other to form a ring or R₅ and R₆ may combine with each other to form a ring; R₇ represents an alkylene group; R₁ represents a hydrogen atom, an alkyl group, an aryl group, an alkoxy group, an alkyleneoxy group or a halogen atom; and R₈ represents a hydrogen atom, —XR₂R₃R₁ or —XR₅R₆R₁.

2. The positive working light sensitive planographic printing plate material of claim 1, wherein the acid decomposable compound represented by formula (1) is an acetal.

3. The positive working light sensitive planographic printing plate material of claim 1, wherein the lower layer further contains an acid generating agent.

4. The positive working light sensitive planographic printing plate material of claim 3, wherein the acid generating agent is a compound represented by the following formula (2),
R¹—C(X)₂—(C═O)—R² Formula (2)
wherein R¹ represents a hydrogen atom, a bromine atom, a chlorine atom, an alkyl group, an aryl group, an acyl group, an alkylsulfonyl group, an arylsulfonyl group, an iminosulfonyl group or a cyano group; R² represents a hydrogen atom or a monovalent organic substituent, provided that R¹ and R² may combine with each other to form a ring; and X represents a bromine atom or a chlorine atom.

5. The positive working light sensitive planographic printing plate material of claim 1, wherein the fluoroalkyl group-containing acryl resin is a resin having in the molecule a monomer unit derived from a monomer represented by the following formula (4), 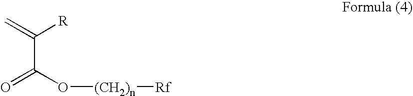
wherein Rf represents a fluoroalkyl group having a fluorine atom number of not less than 3 or a substituent with a fluoroalkyl group having a fluorine atom number of not less than 3; n is 1 or 2; and R represents hydrogen atom or an alkyl group having a carbon atom number of from 1 to 4.

6. The positive working light sensitive planographic printing plate material of claim 5, wherein in formula (4) Rf represents a perfluoroalkyl group or a substituent with a perfluoroalkyl group.

7. The positive working light sensitive planographic printing plate material of claim 1, wherein the upper image formation layer contains a fluoroalkyl group-containing acryl resin in an amount of from 0.01 to 50% by weight.

8. The positive working light sensitive planographic printing plate material of claim 1, wherein the lower image formation layer further contains a fluoroalkyl group-containing acryl resin.

9. The positive working light sensitive planographic printing plate material of claim 1, wherein the aluminum support has on the surface a polyvinyl phosphonic acid layer with a dry thickness of from 0.002 to 0.1μ.

10. A positive working light sensitive planographic printing plate material comprising an aluminum support and provided thereon, a lower image formation layer and an upper image formation layer in that order, wherein the upper image formation layer contains an alkali soluble resin and a light-to-heat conversion material, and the lower image formation layer contains an alkali soluble resin, a fluoroalkyl group-containing acryl resin, and an acid decomposable compound represented by the following formula (1), 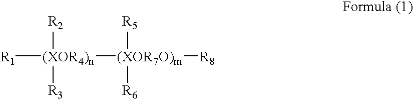
wherein n represents an integer of 1 or more; m represents an integer of 0 or more; X represents a carbon atom or a silicon atom; R₄ represents an ethyleneoxy group or a propyleneoxy group; R₂ and R₅ independently represent a hydrogen atom, an alkyl group or an aryl group; R₃ and R₆ independently represent an alkyl group or an aryl group, provided that R₂ and R₃ may combine with each other to form a ring or R₅ and R₆ may combine with each other to form a ring; R₇ represents an alkylene group; R₁ represents a hydrogen atom, an alkyl group, an aryl group, an alkoxy group, an alkyleneoxy group or a halogen atom; and R₈ represents a hydrogen atom, —XR₂R₃R₁ or —XR₅R₆R₁.
